(19) United States
(12) Patent Application Publication
(10) Pub. No.: US 2024/0174185 A1
(43) Pub. Date: May 30, 2024

(54) IMAGING SYSTEM, IMAGING METHOD, AND MEDIUM

(71) Applicant: Izumi ITOH, Tokyo (JP)

(72) Inventor: Izumi ITOH, Tokyo (JP)

(21) Appl. No.: 18/515,296

(22) Filed: Nov. 21, 2023

(30) Foreign Application Priority Data
Nov. 25, 2022 (JP) 2022-188592

(51) Int. Cl. B60R 11/02; B60R 11/04

(52) U.S. Cl. CPC B60R 11/0264; B60R 11/0229; B60R 11/04; B60R 2300/301; B60R 2300/307

(57) ABSTRACT

An imaging system includes an imaging device and an imaging control device to control operations of the imaging device. The imaging device is installed on a mobile object to image an inspection target object while moving. Respective sides visible from the imaging device when the inspection target object is positioned in forward/sideward/backward directions are defined as front/side/rear surfaces of the inspection target object. The imaging device images the front surface at a first timing when the inspection target object is positioned forward, to obtain a first captured image. The imaging control device controls operations of the imaging device, to obtain a second captured image by imaging at least one of the side surface and the rear surface at a second timing when the inspection target object is positioned sideward or backward.

### CROSS-REFERENCE TO RELATED APPLICATION

The present application is based upon and claims the benefit of priority under 35 U.S.C. § 119 to Japanese Patent Application No. 2022-188592 filed on Nov. 25, 2022, the entire contents of which are hereby incorporated by reference.

### BACKGROUND OF THE INVENTION

### 1. Field of the Invention

The present disclosure relates to an imaging system, an imaging method, and a medium.

### 2. Description of the Related Art

Conventionally, a technique has been known that uses an imaging device installed on a vehicle, captures images of road attachments such as a road sign and a convex traffic mirror at a road curve as inspection target objects while moving, to inspect deformation such as damage to the inspection target objects from the captured images. Note that the road attachment is a fixture or structure necessary for maintaining the structure of a road, ensuring safe and smooth road traffic, and other road management.

As one of the techniques described above, a technique is disclosed that detects a pillar area, a specific color area, and a specific shape area from a captured image of a road on which a vehicle is traveling, to determine that these are road attachments arranged in the surroundings of the road (e.g., see Patent Document 1).

However, the technique of Patent Document 1 is not disclosed from the viewpoint of obtaining multiple captured images of an inspection target object being a road attachment or the like, which are imaged from different directions at multiple viewpoints.

### SUMMARY OF THE INVENTION

According to one aspect of the present invention, an imaging system includes an imaging device; and an imaging control device including a processor and a memory configured to control operations of the imaging device. The imaging device is installed on a mobile object to image an inspection target object while the mobile object is moving. A side visible from the imaging device when the inspection target object is positioned in a forward direction with respect to a traveling direction of the mobile object is defined as a front surface of the inspection target object; a side visible from the imaging device when the mobile object is positioned in a sideward direction with respect to the traveling direction is defined as a side surface of the inspection target object; and a side visible from the imaging device when the mobile object is positioned in a backward direction with respect to the traveling direction is defined as a rear surface of the inspection target object. The imaging device images the front surface of the inspection target object, at a first timing when the inspection target object is positioned in the forward direction with respect to the traveling direction, to obtain a first captured image. The processor of the imaging control device controls operations of the imaging device, to obtain a second captured image by imaging at least one of the side surface or the rear surface of the inspection target object, at a second timing when the inspection target object is positioned in at least one of the sideward direction or the backward direction with respect to the traveling direction.

### BRIEF DESCRIPTION OF DRAWINGS

FIG. 1 is a diagram illustrating an example of an overall configuration of an information processing system according to an embodiment;

FIG. 2 is a diagram illustrating an example of a configuration of an imaging system according to the embodiment;

FIG. 3 is a block diagram illustrating an example of a hardware configuration of an imaging device according to the embodiment;

FIG. 4 is a block diagram illustrating an example of a hardware configuration of the imaging system according to the embodiment;

FIG. 5 is a block diagram illustrating an example of a hardware configuration of an image analysis device according to the embodiment;

FIG. 6 is a block diagram illustrating an example of a hardware configuration of a communication terminal according to the embodiment;

FIG. 7 is a block diagram illustrating an example of a functional configuration of the information processing system according to the embodiment;

FIG. 8 is a diagram illustrating examples of imaging ranges in the imaging system according to the embodiment;

FIG. 9 is a diagram illustrating examples of angles of view of a forward camera in the imaging system according to the embodiment;

FIG. 10 is a diagram illustrating an example of an angle of view of a sideward camera in the imaging system according to the embodiment;

FIG. 11 is a diagram illustrating an example of imaging by the imaging system according to the embodiment;

FIGS. 12A-12C are diagrams exemplifying examples of images captured while a mobile object approaches an inspection target object;

FIGS. 13A-13B are diagrams illustrating examples of captured images of an inspection target object executed by the imaging system;

FIGS. 14A-14B are diagrams illustrating examples of a front surface and a rear surface of a road sign as an inspection target object;

FIG. 15 is a diagram illustrating an example of an inspection target object front surface management DB;

FIG. 16 is a diagram illustrating an example of an inspection target object side surface management DB;

FIG. 17 is a diagram illustrating an example of an inspection target object rear surface management DB;

FIG. 18 is a diagram illustrating an example of a front surface deformation state management DB;

FIG. 19 is a diagram illustrating an example of a side surface deformation state management DB;

FIG. 20 is a diagram illustrating an example of a rear surface deformation state management DB;

FIG. 21 is a sequence chart illustrating an example of overall operations of the information processing system according to the embodiment;

FIG. 22 is a flow chart illustrating an example of imaging control operations executed by the imaging system according to the embodiment;

FIG. 23 is a flow chart illustrating an example of automatic detection operations executed by the imaging system according to the embodiment;

FIG. 24 is a flow chart illustrating an example of manual detection operations executed by the imaging system according to the embodiment;

FIG. 25 is a flow chart illustrating an example of automatic and manual detection operations executed by the imaging system according to the embodiment;

FIG. 26 is a flow chart illustrating an example of analysis operations executed by the imaging system according to the embodiment;

FIG. 27 is a flow chart illustrating an example of setting operations for imaging an inspection target object executed by the imaging system according to the embodiment;

FIG. 28 is a flow chart illustrating an example of overall imaging operations executed by the imaging system according to the embodiment;

FIG. 29 is a flow chart illustrating an example of front surface imaging operations executed by the imaging system according to the embodiment;

FIG. 30 is a flow chart illustrating an example of side surface imaging operations executed by the imaging system according to the embodiment;

FIG. 31 is a flow chart illustrating an example of rear surface imaging operations executed by the imaging system according to the embodiment;

FIG. 32 is a diagram illustrating an example of a front surface imaging timing by the imaging system according to the embodiment;

FIG. 33 is a diagram illustrating an example of a side surface imaging timing by the imaging system according to the embodiment;

FIG. 34 is a diagram illustrating an example of a rear surface imaging timing by the imaging system according to the embodiment;

FIG. 35 is a diagram illustrating an example of a screen display by the information processing system according to the embodiment; and

FIG. 36 is a diagram illustrating a modified example of a configuration of the imaging system according to the embodiment.

### DETAILED DESCRIPTION OF THE EMBODIMENTS

An imaging system, an imaging method, and a medium according to embodiments of the present invention will be described in detail with reference to the drawings.

According to an embodiment, multiple captured images of an inspection target object that are imaged from different directions at multiple viewpoints can be obtained.

The following forms are provided for exemplifying the imaging system, imaging method, and medium for embodying the technical concepts of the present embodiments, and forms are not limited to the following. In addition, the dimensions, materials, shapes, and relative arrangements of the constituent elements described in the embodiments are not intended to limit the scope of the present invention to only those, but are merely illustrative examples. Note that the sizes and positional relationships of members illustrated in the drawings may be exaggerated for the sake of clarifying the description. In addition, in the following description, the same names and symbols indicate members of the same or the same type, and the detailed descriptions may be omitted appropriately.

In the drawings, orthogonal coordinates having X, Y, and Z axes may be used as representation of directions. The X, Y, and Z axes are substantially orthogonal to each other. The Y direction indicates a direction along a traveling direction of a mobile object on which an imaging system according to the embodiment is installed, and the Z direction indicates the vertical direction. However, the representation of directions as such does not limit directions in the embodiment, and the orientation of the imaging system can be set discretionarily.

### EMBODIMENTS

### <Example of Overall Configuration of Information Processing System 1>

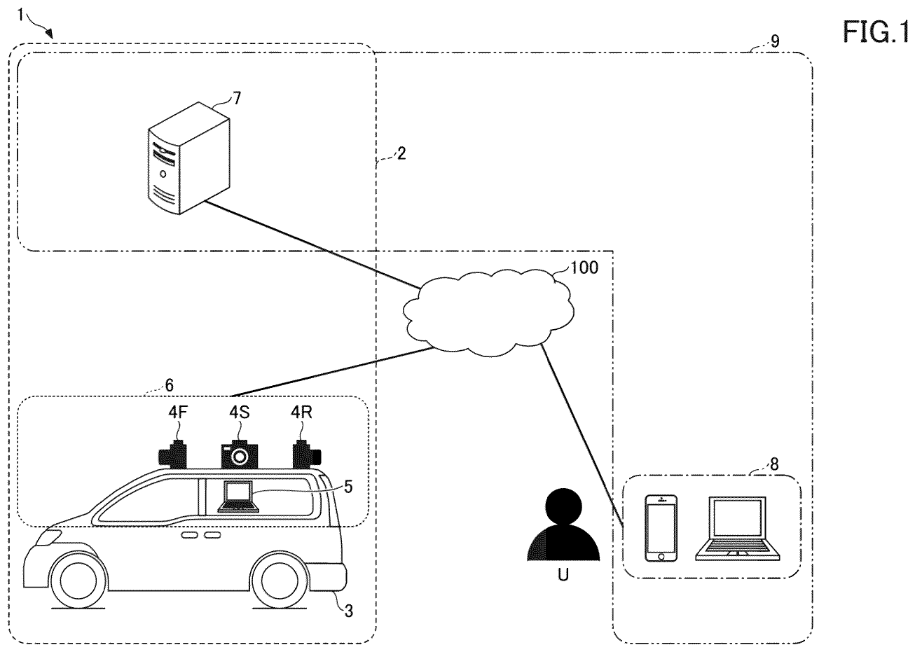

FIG. 1 is a diagram illustrating an example of an overall configuration of an information processing system 1 according to an embodiment. The information processing system 1 includes an imaging system 6, an image analysis device 7, and a communication terminal 8. An inspection system 2 is configured with the imaging system 6 and the image analysis device 7. An inspection result display system 9 is configured with the image analysis device 7 and the communication terminal 8. The imaging system 6, the image analysis device 7, and the communication terminal 8 are communicably connected with each other through a communication network 100. An operator U represents a person who operates the communication terminal 8. Note that the information processing system 1 may include an information processing device such as a personal computer (PC) in addition to the constituent elements described above. In addition, the information processing system 1 may include multiple information processing devices, imaging systems 6, image analysis devices 7, and communication terminals 8.

### <Example of Configuration of Imaging System 6>

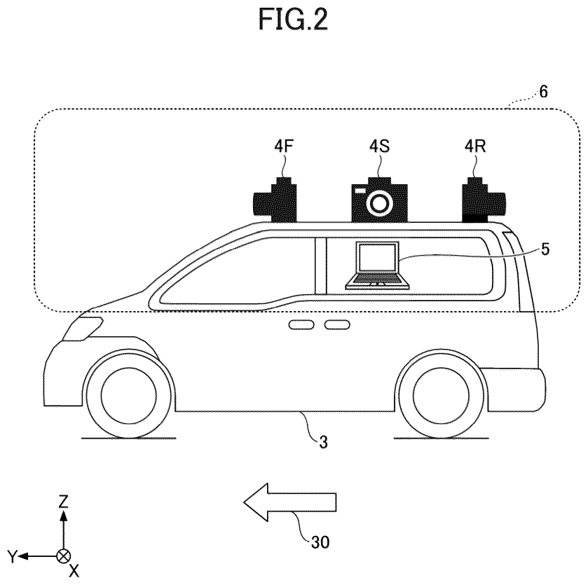

FIG. 2 is a diagram illustrating an example of a configuration of the imaging system 6. The imaging system 6 is a system that is installed on a mobile object 3, and executes imaging while being moved with movement of the mobile object 3. Here, the mobile object 3 is assumed to move in a traveling direction 30 corresponding to the positive direction along the Y axis. However, the traveling direction of the mobile object 3 can be set discretionarily. The mobile object 3 is, for example, a vehicle. The vehicle includes an automobile, a train, an automatic guided vehicle (AGV), and the like.

The imaging system 6 includes an imaging device 4 and an imaging control device 5.

The imaging device 4 is installed on the mobile object 3 to image an inspection target object while the mobile object 3 is moving. In the present embodiment, the imaging device 4 images the front surface of the inspection target object at a first timing when the inspection target object is positioned in the forward direction with respect to the traveling direction 30, to obtain a first captured image. This inspection target object is a road attachment such as a guide sign, a regulation sign, a convex traffic mirror at a road curve, or the like.

In the present embodiment, the imaging device 4 includes a forward camera 4F, a sideward camera 4S, and a backward camera 4R. Here, a side visible from the imaging device 4 when an inspection target object is positioned in the forward direction with respect to the traveling direction 30 of the mobile object 3 is defined as a front surface of the inspection target object; a side visible from the imaging device 4 when the mobile object 3 is positioned in the sideward direction with respect to the traveling direction 30 is defined as a side surface of the inspection target object; and a side visible from the imaging device 4 when the mobile object 3 is positioned in the backward direction with respect to the traveling direction 30 is defined as a rear surface of the inspection target object. The forward camera 4F is arranged to be capable of imaging the front surface of the inspection target object. The sideward camera 4S is arranged to be capable of imaging the side surface of the inspection target object. The backward camera 4R is arranged to be capable of imaging the rear surface of the inspection target object.

In examples illustrated in the present specification, the forward camera 4F, the sideward camera 4S, and the backward camera 4R each have the same configuration. In the case where the forward camera 4F, the sideward camera 4S, and the backward camera 4R are not distinguished from one another, these are collectively referred to as the imaging device(s) 4. However, the forward camera 4F, the sideward camera 4S, and the backward camera 4R may have different configurations.

The imaging control device 5 controls operations of the imaging device 4. In the present embodiment, the imaging control device 5 controls operations of the imaging device 4 to obtain a second captured image by imaging at least one of the side surface or the rear surface of the inspection target object, at a second timing when the inspection target object is positioned in at least one of the sideward direction and the backward direction with respect to the traveling direction 30.

### <Example of Hardware Configuration of Information Processing System 1>

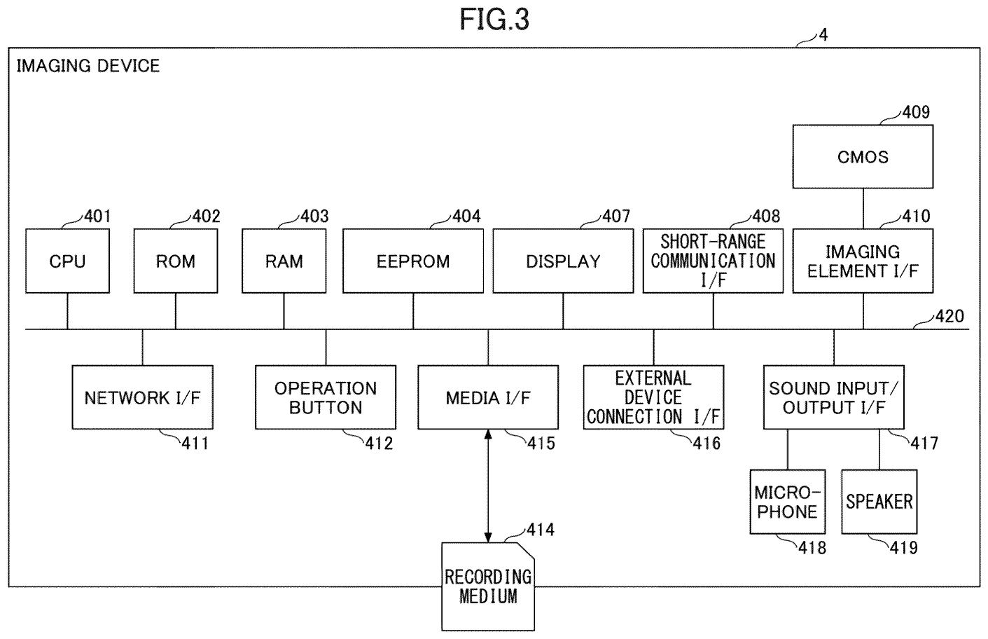

With reference to FIGS. 3 to 6, a hardware configuration of each of the constituent elements included in the information processing system 1 will be described.

### (Imaging Device 4)

FIG. 3 is a block diagram illustrating an example of a hardware configuration of the imaging device 4. The imaging device 4 includes a CPU (Central Processing Unit) 401, a ROM (Read-Only Memory) 402, a RAM (Random Access Memory) 403, an EEPROM (Electrically Erasable Programmable Read-Only Memory) 404, a display 407, and a short-range communication I/F (Interface) 408. In addition, the imaging device 4 includes a CMOS (Complementary Metal Oxide Semiconductor) sensor 409, an imaging element I/F 410, a network I/F 411, an operation button 412, a media I/F 415, an external device connection I/F 416, a sound input/output I/F 417, a microphone 418, and a speaker 419.

The CPU 401 controls operations of the entire imaging device 4. The ROM 402 stores programs used for the CPU 401 and for driving the CPU 401 such as an IPL. The RAM 403 is used as a work area of the CPU 401. The EEPROM 404 reads or writes various items of data such as programs for the imaging device 4 under control of the CPU 401.

The display 407 is a type of display unit of liquid crystal or organic EL (Electro Luminescence) that displays an image of a subject or various icons. The short-range communication I/F 408 is a communication circuit such as NFC (Near Field Communication) or Bluetooth (registered trademark). The CMOS sensor 409 is a type of built-in imaging unit that captures an inspection target object to obtain image data under control of the CPU 401. Note that the CMOS sensor 409 may be replaced with an imaging unit such as a CCD (Charge Coupled Device) sensor. The imaging element I/F 410 is a circuit that controls driving of the CMOS sensor 409.

The network I/F 411 is an interface for communicating with other devices via the communication network 100. The operation button 412 is a type of input unit for operating the imaging device 4 when being pressed by the user. The media I/F 415 controls reading or writing (storing) of data on the recording medium 414 such as a flash memory. The external device connection I/F 416 is an interface for connecting various external devices.

The sound input/output I/F 417 is a circuit for processing input/output of sound signals through the microphone 418 and the speaker 419 under control of the CPU 401. The microphone 418 is a built-in circuit for converting sound into electric signals. The speaker 419 is a built-in circuit for converting electric signals into physical vibrations to produce sound such as music and speech.

In addition, the imaging device 4 is provided with a bus-line 420. The bus-line 420 is an address bus, a data bus, or the like for electrically connecting the constituent elements including the CPU 401 and the like to each other.

### (Imaging System 6)

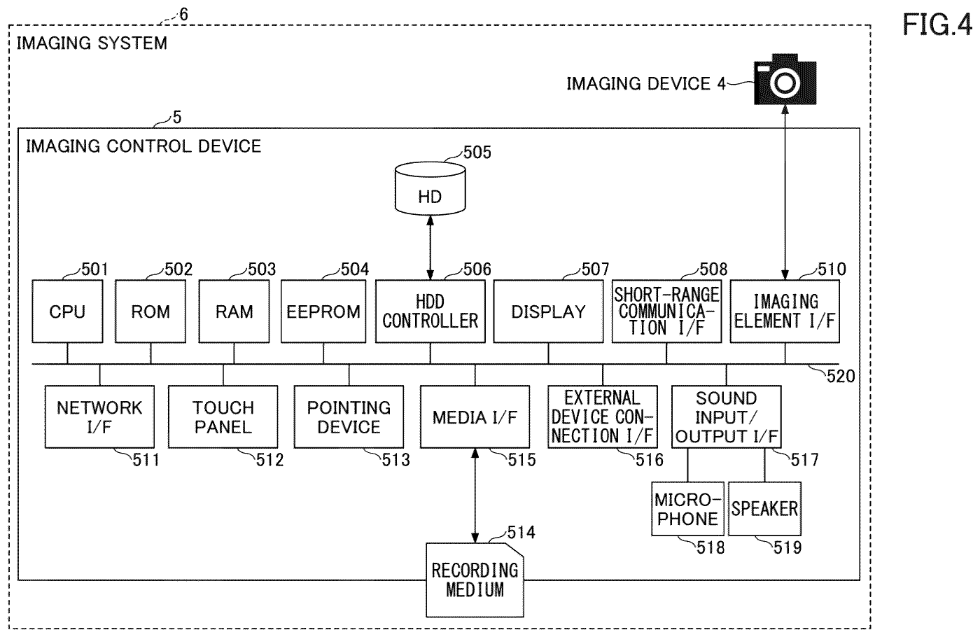

FIG. 4 is a block diagram illustrating an example of a hardware configuration of the imaging system 6. The imaging system 6 include the imaging device 4 and the imaging control device 5. The imaging control device 5 is configured with a computer. The imaging control device 5 includes a CPU 501, a ROM 502, a RAM 503, an EEPROM 504, an HD 505, an HDD (Hard Disk Drive) controller 506, a display 507, a short-range communication I/F 508, and an imaging element I/F 510. In addition, the imaging control device 5 includes a network I/F 511, a touch panel 512, a pointing device 513, a media I/F 515, an external device connection I/F 516, a sound input/output I/F 517, a microphone 518, a speaker 519, and a data bus 520.

The CPU 501 controls operations of the entire imaging control device 5. The ROM 502 stores a program used for driving the CPU 501, such as an IPL. The RAM 503 is used as a work area of the CPU 501. The EEPROM 504 reads or writes various items of data such as programs for the imaging control device 5 under control of the CPU 501. The HD 505 stores various items of data such as programs. The HDD controller 506 controls reading or writing of various items of data on the HD 505 under control of the CPU 501.

The display 507 displays various information items such as a cursor, a menu, a window, a character, or an image. The short-range communication I/F 508 is a communication circuit such as NFC or Bluetooth. The imaging element I/F 510 is a circuit for controlling communication with the imaging device 4. The network I/F 511 is an interface for data communication using the communication network 100. The touch panel 512 is a type of input unit that operates the imaging control device 5 when the user presses the display 507. The pointing device 513 is a type of input unit that selects and executes various commands, selects a processing target, moves a cursor, and so on. The media I/F 515 controls reading or writing (storage) of data on the recording medium 514 such as a flash memory.

The external device connection I/F 516 is an interface for connecting various external devices. The external device in this case is a USB (Universal Serial Bus) memory, printer, or the like. The sound input/output I/F 517 is a circuit for processing input/output of sound signals through the microphone 518 and the speaker 519 under control of the CPU 501. The microphone 518 is a built-in circuit for converting sound into electric signals. The speaker 519 is a built-in circuit for converting electric signals into physical vibrations to produce sound such as music and voice.

The data bus 520 is an address bus, a data bus, or the like for electrically connecting the constituent elements including the CPU 501 and the like to each other.

### (Image Analysis Device 7)

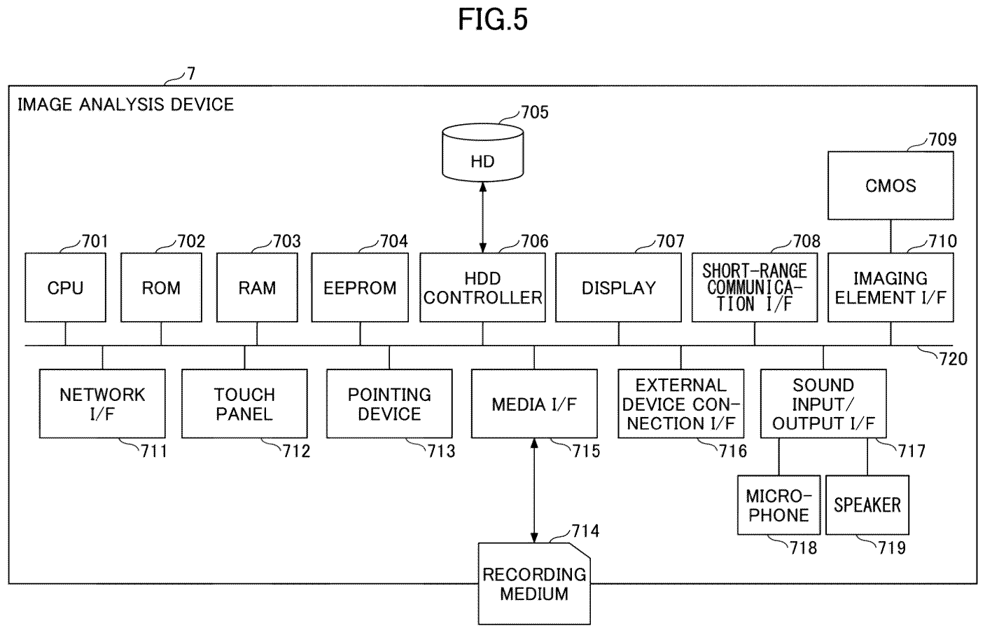

FIG. 5 is a block diagram illustrating an example of a hardware configuration of the image analysis device 7. The image analysis device 7 is configured with a computer. The image analysis device 7 includes a CPU 701, a ROM 702, a RAM 703, an EEPROM 704, an HD 705, an HDD controller 706, a display 707, a short-range communication I/F 708, and a CMOS sensor 709. In addition, the image analysis device 7 includes an imaging element I/F 710, a network I/F 711, a touch panel 712, a pointing device 713, a media I/F 715, an external device connection I/F 716, a sound input/output I/F 717, a microphone 718, a speaker 719, and a data bus 720.

The CPU 701 controls operations of the entire image analysis device 7. The ROM 702 stores a program used for driving the CPU 701, such as an IPL. The RAM 703 is used as a work area of the CPU 701. The EEPROM 704 reads or writes various items of data such as programs for the image analysis device 7 under control of the CPU 701. The HD 705 stores various items of data such as programs. The HDD controller 706 controls reading or writing of various items of data on the HD 705 under control of the CPU 701.

The display 707 displays various information items such as a cursor, a menu, a window, a character, or an image. The short-range communication I/F 708 is a communication circuit such as NFC or Bluetooth. The CMOS sensor 709 is a type of built-in imaging unit that captures an inspection target object to obtain image data under control of the CPU 701. Note that the CMOS sensor 709 may be replaced with an imaging unit such as a CCD sensor. The imaging element I/F 710 is a circuit for controlling communication with the imaging device 4.

The network I/F 711 is an interface for data communication using the communication network 100. The touch panel 712 is a type of input unit that operates the image analysis device 7 when the user presses the display 707. The pointing device 713 is a type of input unit that selects and executes various commands, selects a processing target, moves a cursor, and so on. The media I/F 715 controls reading or writing (storage) of data on the recording medium 714 such as a flash memory.

The external device connection I/F 716 is an interface for connecting various external devices. The external device in this case is, for example, a USB memory or a printer. The sound input/output I/F 717 is a circuit for processing input/output of sound signals through the microphone 718 and the speaker 719 under control of the CPU 701. The microphone 718 is a built-in circuit for converting sound into electric signals. The speaker 719 is a built-in circuit for converting electric signals into physical vibrations to produce sound such as music and voice.

The data bus 720 is an address bus, a data bus, or the like for electrically connecting the constituent elements including the CPU 701 and the like to each other.

### (Communication Terminal 8)

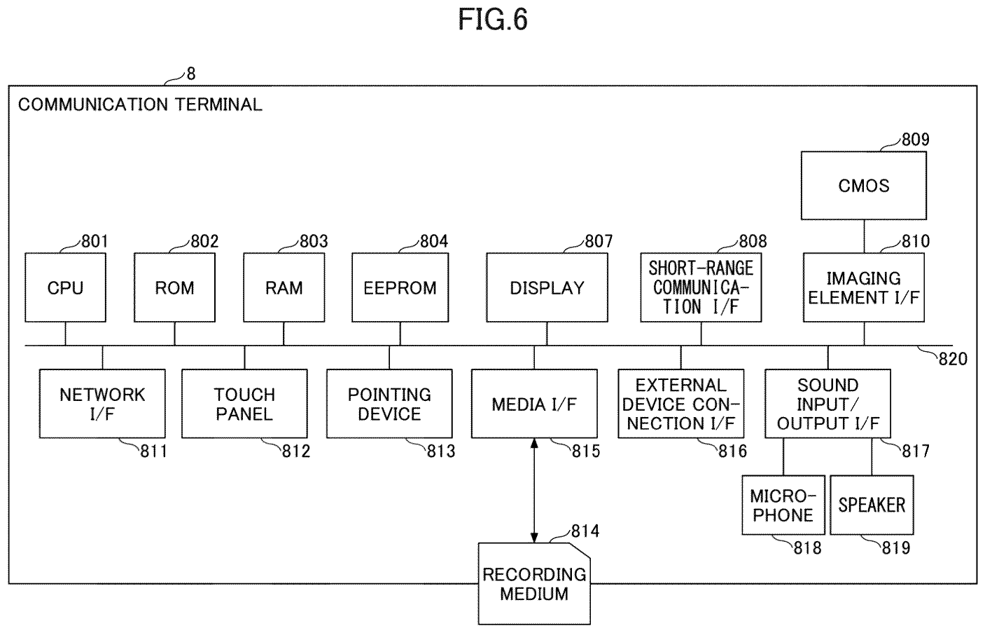

FIG. 6 is a block diagram illustrating an example of a hardware configuration of the communication terminal 8. The communication terminal 8 includes a CPU 801, a ROM 802, a RAM 803, an EEPROM 804, a display 807, a short-range communication I/F 808, a CMOS sensor 809, and an imaging element I/F 810. In addition, the communication terminal 8 includes a network I/F 811, a touch panel 812, a pointing device 813, a media I/F 815, an external device connection I/F 816, a sound input/output I/F 817, a microphone 818, and a speaker 819.

The CPU 801 controls operations of the entire communication terminal 8. The ROM 802 stores programs used for the CPU 801 and for driving the CPU 801 such as an IPL. The RAM 803 is used as a work area of the CPU 801. The EEPROM 804 reads or writes various items of data such as programs for the communication terminal 8 under control of the CPU 801.

The display 807 is a type of display unit of liquid crystal or organic EL that displays an image of a subject or various icons. The short-range communication I/F 808 is a communication circuit such as NFC or Bluetooth. The CMOS sensor 809 is a type of built-in imaging unit that captures an inspection target object to obtain image data under control of the CPU 801. Note that the CMOS sensor 809 may be replaced with an imaging unit such as a CCD sensor. The imaging element I/F 810 is a circuit that controls driving of the CMOS sensor 809.

The network I/F 811 is an interface for communicating with other devices via the communication network 100. The touch panel 812 is a type of input unit that operates the communication terminal 8 when being pressed by the user. The media I/F 815 controls reading or writing (storage) of data on the recording medium 814 such as a flash memory. The external device connection I/F 816 is an interface for connecting various external devices.

The sound input/output I/F 817 is a circuit for processing input/output of sound signals through the microphone 818 and the speaker 819 under control of the CPU 801. The microphone 818 is a built-in circuit for converting sound into electric signals. The speaker 819 is a built-in circuit for converting electric signals into physical vibrations to produce sound such as music and voice.

In addition, the communication terminal 8 is provided with a bus-line 820. The bus-line 820 is an address bus, a data bus, or the like for electrically connecting the constituent elements including the CPU 801 and the like to each other.

### <Example of Functional Configuration of Information Processing System 1>

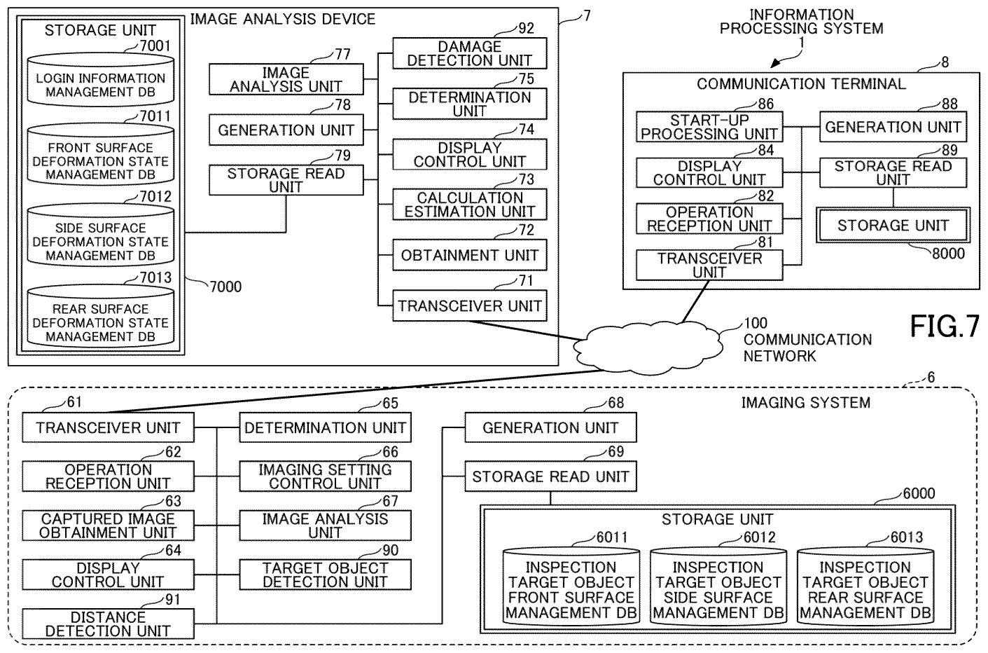

FIG. 7 is a block diagram illustrating an example of a functional configuration of the information processing system 1.

### (Imaging System 6)

The imaging system 6 includes a transceiver unit 61, an operation reception unit 62, a captured image obtainment unit 63, a display control unit 64, a determination unit 65, an imaging setting control unit 66, an image analysis unit 67, a generation unit 68, a storage read unit 69, a target object detection unit 90, a distance detection unit 91, and a storage unit 6000.

Functions of the transceiver unit 61 are implemented by the network I/F 511 or the like in FIG. 4. Functions of the operation reception unit 62 are implemented by the touch panel 512, the pointing device 513, and the like in FIG. 4. Respective functions of the captured image obtainment unit 63, the display control unit 64, the determination unit 65, the imaging setting control unit 66, the image analysis unit 67, the generation unit 68, the target object detection unit 90, and the distance detection unit 91 are implemented by, for example, the CPU 501 in FIG. 4 that loads a program stored in the ROM 502 or the like to the RAM 503 and executes processing specified in the program. Functions of the storage read unit 69 are implemented by the HDD controller 506 or the like in FIG. 4. Functions of the storage unit 6000 are implemented by the HD 505 or the like in FIG. 4.

The transceiver unit 61 controls communication between the imaging system 6 and an external device via the communication network 100. The operation reception unit 62 receives operations performed by the operator of the imaging system 6. The captured image obtainment unit 63 obtains images captured by the imaging device 4. The display control unit 64 controls displaying of a screen on the display 407 in the imaging device 4, the display 507 in the imaging control device 5, or the like. The determination unit 65 executes various determination operations in the imaging system 6. The imaging setting control unit 66 controls settings such as imaging conditions by the imaging device 4. The image analysis unit 67 executes an analysis process of a captured image obtained by the captured image obtainment unit 63. The generation unit 68 generates a screen or the like to be displayed on the display 407, the display 507, or the like. The storage unit 6000 stores an inspection target object front surface management DB (Data Base) 6011, an inspection target object side surface management DB 6012, and an inspection target object rear surface management DB 6013.

In the present embodiment, the target object detection unit 90 detects an inspection target object based on at least one of the first captured image or the second captured image. Here, “detecting an inspection target object” means determining whether a target object to be inspected (a desired target object) appears in an image captured by the imaging system 6. In the following, the desired target object will be referred to as the inspection target object A. Note that the inspection target object does not need to be of one type, but may be of multiple types. The first captured image is an image obtained by imaging the front surface of an inspection target object, at a first timing when the inspection target object is positioned in the forward direction with respect to the traveling direction 30. The second captured image is an image obtained by imaging at least one of the side surface or the rear surface of the inspection target object, at a second timing when the inspection target object is positioned in at least one of the sideward direction or the backward direction with respect to the traveling direction 30.

In the present embodiment, the target object detection unit 90 detects an inspection target object using a deep neural network (DNN) or the like. For example, the inspection target object front surface management DB 6011, the inspection target object side surface management DB 6012, and the inspection target object rear surface management DB 6013 store a trained model or a model under training used for detecting an inspection target object. The target object detection unit 90 detects an inspection target object by the DNN with reference to the trained model or the model under training. The inspection target object front surface management DB 6011 is used when the target object detection unit 90 detects an inspection target object based on a first captured image. The inspection target object side surface management DB 6012 and the inspection target object rear surface management DB 6013 are used when the target object detection unit 90 detects an inspection target object based on a second captured image. Note that in the case of using the model under training, the target object detection unit 90 updates the model under training while using the model under training.

In addition, in the present embodiment, the distance detection unit 91 detects a distance between the inspection target object A and the mobile object 3. In this case, the distance includes distances for imaging the inspection target object A by the forward camera 4F, the sideward camera 4S, and the backward camera 4R, respectively, and means distances between a surface of the inspection target object A facing the mobile object 3, and the respective imaging surfaces of the forward camera 4F, the sideward camera 4S, and the backward camera 4R in the imaging system 6. The distance detection unit 91 can detect a distance between the inspection target object A and the mobile object 3 based on, for example, the size of the inspection target object A included in a captured image. The target object detection unit 90 described above may detect the inspection target object A based on at least one of the distances between the inspection target object A and the mobile object 3 detected by the distance detection unit 91, the first captured image, and the second captured image.

### (Image Analysis Device 7)

The image analysis device 7 includes a transceiver unit 71, an obtainment unit 72, a calculation estimation unit 73, a display control unit 74, a determination unit 75, an image analysis unit 77, a generation unit 78, a storage read unit 79, a damage detection unit 92, and a storage unit 7000.

Functions of the transceiver unit 71 are implemented by the network I/F 711 or the like in FIG. 5. Respective functions of the obtainment unit 72, the calculation estimation unit 73, the display control unit 74, the determination unit 75, the image analysis unit 77, the generation unit 78, and the damage detection unit 92 are implemented by, for example, the CPU 701 in FIG. 5 that loads a program stored in the ROM 702 or the like to the RAM 703 and executes processing specified in the program. Functions of the storage read unit 79 are implemented by the HDD controller 706 or the like in FIG. 5. Functions of the storage unit 7000 are implemented by the HD 705 or the like in FIG. 5.

The transceiver unit 71 controls communication between the image analysis device 7 and an external device via the communication network 100. The obtainment unit 72 obtains a captured image obtained by the imaging system 6 via the communication network 100. The calculation estimation unit 73 executes various estimation processes based on captured images obtained by the obtainment unit 72. The display control unit 74 controls displaying of a screen on the display 707 and the like. The determination unit 75 executes various determination operations in the image analysis device 7. The image analysis unit 77 executes an analysis process of a captured image obtained by the obtainment unit 72. The generation unit 78 generates a screen or the like to be displayed on the display 707 or the like. The storage unit 7000 stores a login information management DB 7001, a front surface deformation state management DB 7011, a side surface deformation state management DB 7012, and a rear surface deformation state management DB 7013.

In the present embodiment, the damage detection unit 92 detects damage to the inspection target object. For example, the inspection target object includes a sign, a pillar part supporting the sign, and a fixing member fixing the sign to the pillar part. A sign is, for example, a road sign. A pillar part is, for example, a pillar that supports the road sign. A fixing member is a screw member, for example, a bolt that is fastened to fix the road sign to the pillar.

In the present embodiment, based on at least one of the first captured image or the second captured image, the damage detection unit 92 detects at least one of deformation from the predetermined shape of the sign, deformation of the pillar part, or loosening of the fixing member. In other words, based on at least one of the first captured image or the second captured image, the damage detection unit 92 determines that damage occurs as at least one of deformation from the predetermined shape of the sign, deformation of the pillar part, or loosening of the fixing member.

In the present embodiment, the damage detection unit 92 detects damage to the inspection target object using a deep neural network or the like. For example, in the storage unit 7000, the front surface deformation state management DB 7011, the side surface deformation state management DB 7012, and the rear surface deformation state management DB 7013 store a trained model or a model under training used for detecting damage to an inspection target object. The damage detection unit 92 detects damage to an inspection target object by the DNN with reference to the trained model or the model under training. The front surface deformation state management DB 7011 is used when the damage detection unit 92 detects damage to an inspection target object based on a first captured image. The side surface deformation state management DB 7012 and the rear surface deformation state management DB 7013 are used when the damage detection unit 92 detects the damage to the inspection target object based on a second captured image. Note that in the case of using the model under training, the damage detection unit 92 updates the model under training while using the model under training.

Functions of the damage detection unit 92 in the image analysis device 7 may be provided on the imaging system 6.

### (Communication Terminal 8)

The communication terminal 8 includes a transceiver unit 81, an operation reception unit 82, a display control unit 84, a start-up processing unit 86, a generation unit 88, a storage read unit 89, and a storage unit 8000.

Functions of the transceiver unit 81 are implemented by the network I/F 811 or the like in FIG. 6. Functions of the operation reception unit 82 are implemented by the touch panel 812, the pointing device 813, and the like in FIG. 6. Respective functions of the display control unit 84, the start-up processing unit 86, and the generation unit 88 are implemented by, for example, the CPU 801 in FIG. 6 that loads a program stored in the ROM 802 or the like to the RAM 803 and executes processing specified in the program. Functions of the storage read unit 89 are implemented by the media I/F 815 or the like in FIG. 6. Functions of the storage unit 8000 is implemented by the recording medium 814 or the like in FIG. 6.

The transceiver unit 81 controls communication between the communication terminal 8 and an external device via the communication network 100. The operation reception unit 82 receives operations performed by the operator of the communication terminal 8. The display control unit 84 controls displaying of a screen on the display 807 and the like. In the present embodiment, the display control unit 84 displays a result of detection of damage obtained by the damage detection unit 92. The start-up processing unit 86 executes a predetermined process upon starting up the communication terminal 8. The generation unit 88 generates a screen or the like to be displayed on the display 807 or the like. The storage unit 8000 stores various items of setting information and the like.

### <Example of Imaging Ranges in Imaging System 6>

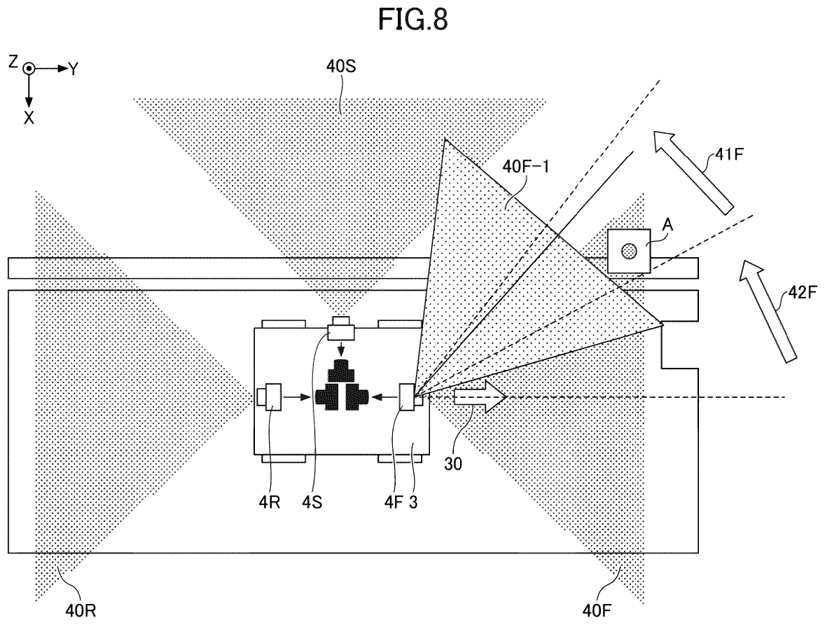

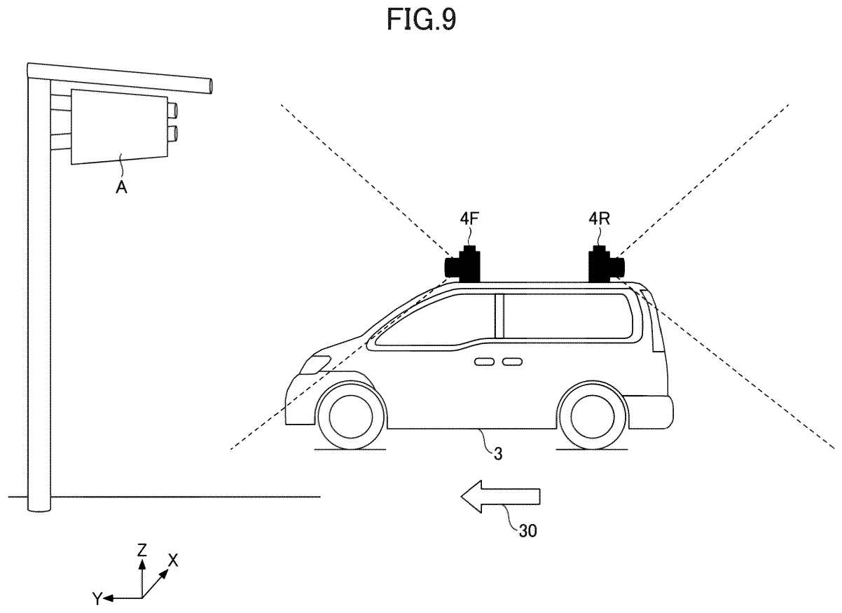

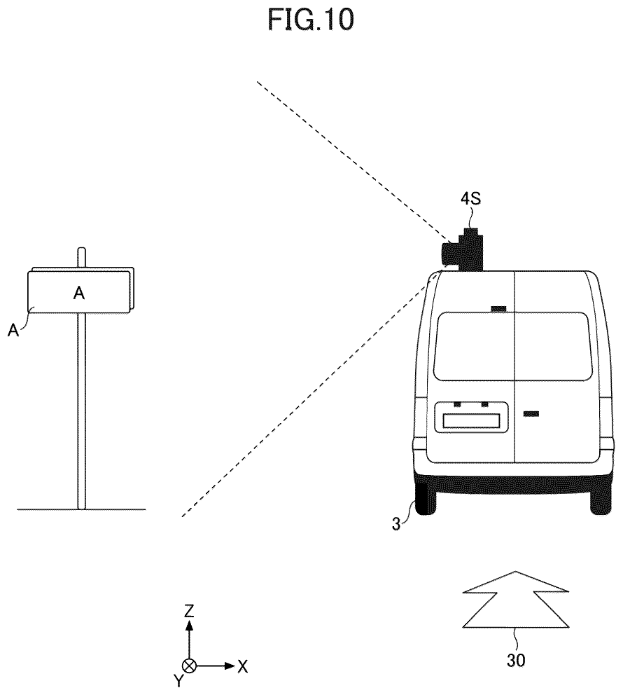

With reference to FIGS. 8 to 10, imaging ranges in the imaging system 6 will be described. FIG. 8 is a diagram illustrating examples of imaging ranges in the imaging system 6. FIG. 9 is a diagram illustrating examples of angles of view in the vertical direction of the forward camera 4F and the backward camera 4R. FIG. 10 is a diagram illustrating an example of an angle of view in the vertical direction of the sideward camera 4S.

In FIG. 8, an imaging range 40F indicates the imaging range of the forward camera 4F. An imaging range 40S indicates the imaging range of the sideward camera 4S. An imaging range 40R indicates the imaging range of the backward camera 4R. As illustrated in FIG. 8, the imaging range 40F, the imaging range 40S, and the imaging range 40R are ranges different from each other. However, the respective imaging ranges of the imaging range 40F, the imaging range 40S, and the imaging range 40R may overlap at least partially.

In addition, each of the forward camera 4F, sideward camera 4S, and backward camera 4R can change its own imaging range. In FIG. 8, an imaging range 40F-1 indicates an imaging range of the forward camera 4F after changing the imaging range. Arrows 41F and 42F indicate a process in which the forward camera 4F changes its orientation to change the imaging range.

As illustrated in FIG. 9, the angle of view of the forward camera 4F in the vertical direction (Z-axis direction) is defined such that a traffic signal as the inspection target object A is included at least within the imaging range. The angle of view of the backward camera 4R in the vertical direction is determined in substantially the same way as the angle of view of the forward camera 4F in the vertical direction. As illustrated in FIG. 10, the angle of view of the sideward camera 4S in the vertical direction is determined such that a road sign as the inspection target object A is included in the imaging range.

### <Example of Imaging Using Imaging System 6>

An example of imaging using the imaging system 6 will be described.

First, definitions of terms will be described. A “captured image for inspection” is defined as a photograph image captured by an imaging device installed on a mobile object. The “captured image for inspection” is distinguished among a “captured image for inspection” captured by the forward camera 4F as a “captured image for forward inspection”; a “captured image for inspection” captured by the sideward camera 4S as a “captured image for sideward inspection”; and a “captured image for inspection” captured by the backward camera 4R as a “captured image for backward inspection”. Each of these “captured image for forward inspection”, “captured image for sideward inspection”, and “captured image for backward inspection” includes multiple images obtained by continuously capturing images.

The imaging device 4 continuously images still images. However, the imaging system 6 may capture a video instead of continuously imaging still images.

An image for determining whether a subject captured by the imaging device 4 is an inspection target object is defined as a “image for determination”. An image for determining whether to start or stop imaging of an inspection target object is defined as a “reference image for imaging”. An image for inspecting an inspection target object by comparing with multiple captured images for inspection obtained by imaging is defined as a “reference image for inspection”. These “image for determination”, “reference image for imaging”, and “reference image for inspection” are all images imaged at substantially the same imaging position and imaging angle as in the case where the inspection target object A is imaged from the imaging device 4 installed on the mobile object 3.

The definitions of the images used for imaging operations and inspection operations will be described in more detail. Note that values such as numbers and number of sheets are values provided for the sake of convenience in order to make the description easier to understand.

### (Image for Determination)

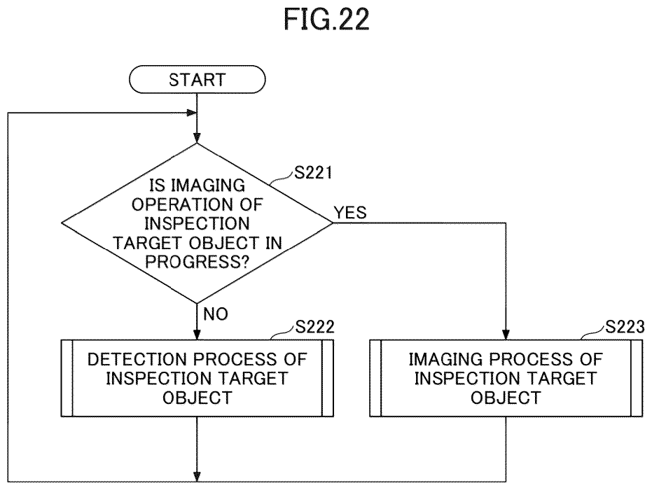

The “image for determination” is an image for determining whether a subject imaged (detected) by the imaging device is the inspection target object A in detection operations of an inspection target object, and for determining whether to start the imaging control operations (S223 in FIG. 22 that will be described later). For example, in the case of starting an imaging operation for inspection at a point of time when the inspection target object A is present at 1 m away from the mobile object in the forward direction, the “image for determination” is an image imaged the inspection target object at a position 1.2 m away from the mobile object in the forward direction before reaching the 1 m-away position in the forward direction. In this case, the distance corresponds to the length between the reference position of the distance on the inspection target object A side and the reference position on the imaging device side, for example, in the case where the inspection target object A is in the forward direction of the mobile object 3, a face (the front surface) on the mobile object 3 side is set as the reference position of the distance on the inspection target object A side, and the imaging surface of the forward camera 4F is set as the reference position on the imaging device side.

### (Reference Image for Imaging)

The “reference image for imaging” is an image for determining whether to save the subject imaged by the imaging device 4 as a captured image for inspection used for inspection in the imaging operations of the inspection target object A. The “captured image for inspection” is imaged at predetermined intervals within a predetermined range forward and backward along the moving direction of the mobile object 3 around a center being the position where the “reference image for imaging” is imaged. The “reference image for imaging” is an image captured near the center of the predetermined range forward and backward along the moving direction of the mobile object 3. There are three types of “reference images for imaging”: a “reference image for forward imaging” for the forward camera 4F; a “reference image for sideward imaging” for the sideward camera 4S; and a “reference image for backward imaging” for the backward camera 4R.

### (Reference Image for Forward Imaging)

For example, in the case where the inspection target object A present in the forward direction of the mobile object 3 is imaged by the forward camera 4F installed in the forward direction of the mobile object 3, if the inspection target object A is imaged within a range from 1 m to 20 cm in the forward direction of the mobile object 3, the “reference image for forward imaging” is a captured image of the inspection target object A imaged at a position at 60 cm away in the forward direction of the mobile object 3.

### (Reference Image for Sideward Imaging)

In the case where the inspection target object A present in the sideward direction of the mobile object 3 is imaged by the sideward camera 4S installed in the sideward direction of the mobile object 3, the “reference image for sideward imaging” is a captured image of the inspection target object positioned on the optical axis of the sideward camera 4S.

### (Reference Image for Backward Imaging)

For example, in the case where the inspection target object A present in the backward direction of the mobile object 3 is imaged by the backward camera 4R installed in the backward direction of the mobile object 3, if the inspection target object A is imaged within a range from 1 m to 20 cm in the backward direction of the mobile object 3, the “reference image for backward imaging” is a captured image of the inspection target object A imaged at a position at 60 cm away in the backward direction of the mobile object 3.

### (Reference Image for Inspection)

The “reference image for inspection” is an image for extracting deformation of the inspection target object A, and the deformation extraction is executed by comparing “the reference image for inspection with the “captured image for inspection”. With respect to the inspection target object A before use that has not deteriorated, an image captured at substantially the same imaging position and imaging angle as in the case where the inspection target object A is captured from the imaging device 4 installed on the mobile object 3 is set as the “reference image for inspection”. The “reference image for inspection” may be set as the “reference image for imaging”. However, the inspection target object A may be deteriorated due to color fading or change in shape. Therefore, among the “captured images for inspection” imaged when the previous inspection was executed, a “captured image for inspection” imaged at substantially the same imaging position and imaging angle as the “reference image for imaging” may be set as the “reference image for imaging”.

There are three types of “reference images for inspection”: a “reference image for forward inspection” for inspecting a “captured image for forward inspection”; a “reference image for sideward inspection” for inspecting a “captured image for sideward inspection”; and a “reference image for backward inspection” for inspecting a “captured image for backward inspection”.

### (Reference Image for Forward Inspection)

For example, in the case of inspecting a “captured image for forward inspection” imaged by the forward camera 4F installed in the forward direction of the mobile object 3, in which the inspection target object A is present in the forward direction of the mobile object 3, if inspection is to be executed on the “captured image for forward inspection” in which the inspection target object A is imaged within a range from 1 m to 20 cm in the forward direction of the mobile object 3, the “reference image for forward inspection” includes multiple images captured in predetermined increments within the range from 1 m to 20 cm in the forward direction of the mobile object 3. For example, in the case where the inspection target object A is imaged in increments of 20 cm, the images are five images of the inspection target object A captured at positions 1 m, 80 cm, 60 cm, 40 cm, and 20 cm in the forward direction.

### (Reference Image for Sideward Inspection)

In the case of inspecting a “captured image for sideward inspection” imaged by the sideward camera 4S installed in the sideward direction of the mobile object 3, in which the inspection target object A is present in the sideward direction of the mobile object 3, the “reference image for sideward inspection” includes a captured image of the inspection target object A positioned on the optical axis of the sideward camera 4S, and captured images of the inspection target object positioned at predetermined angles from the optical axis within the angle of view of the photographic lens of the sideward camera 4S. For example, the images are five captured images of the inspection target object A positioned at +40 degrees, +20 degrees, 0 degrees, −20 degrees, and −40 degrees from the optical axis.

### (Reference Image for Backward Inspection)

For example, in the case where the inspection target object A present in the backward direction of the mobile object 3 is imaged by the backward camera 4R installed in the backward direction of the mobile object 3, if the inspection target object A is imaged within a range from 1 m to 20 cm in the backward direction of the mobile object 3, the “reference image for backward imaging” is a captured image of the inspection target object A imaged at a position at 60 cm away in the backward direction of the mobile object 3.

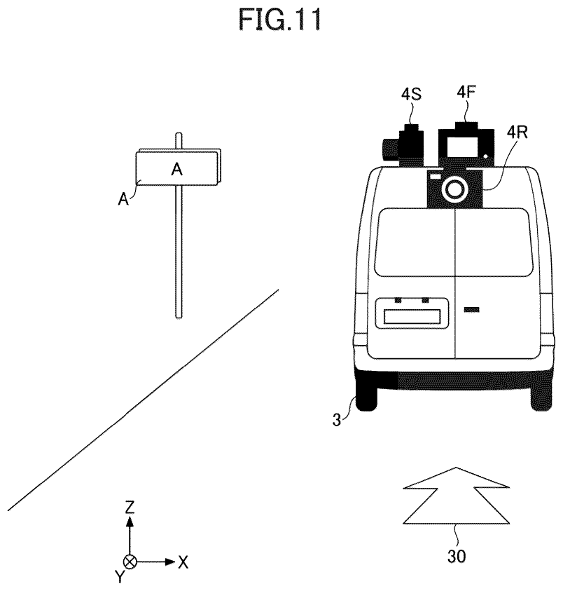

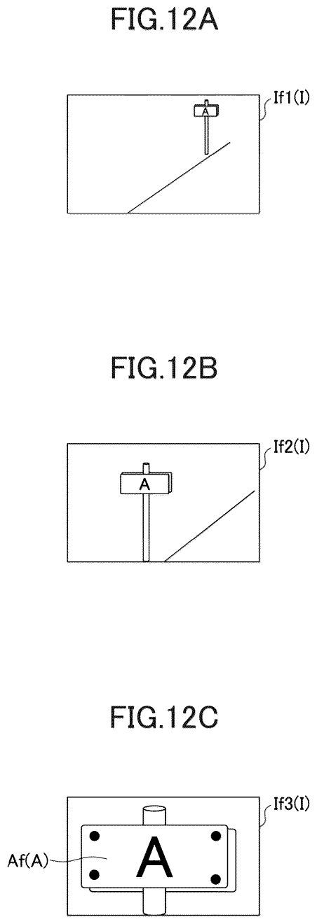

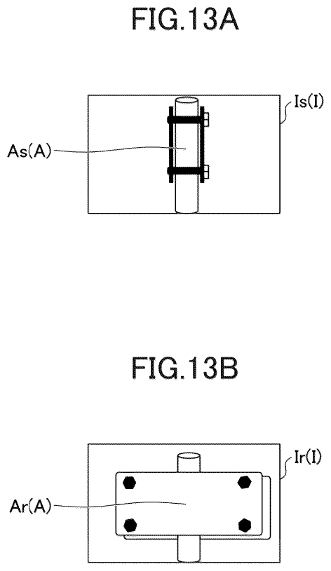

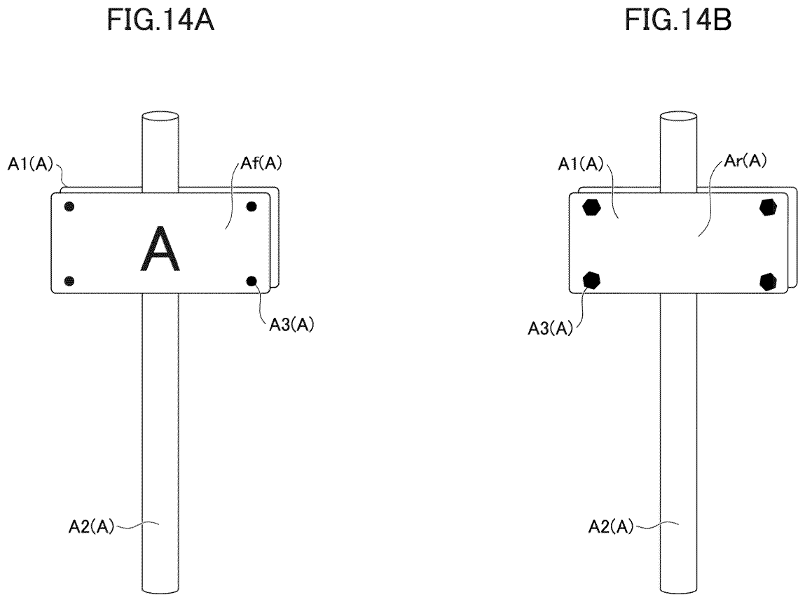

With reference to FIGS. 11 to 14, situations of imaging by the imaging system 6 will be described. FIG. 11 is a diagram illustrating an example of imaging by the imaging system 6. FIGS. 12A-12C are diagrams illustrating examples of images captured while the mobile object 3 approaches the inspection target object A. FIGS. 13A-13B are diagrams illustrating examples of captured images of the inspection target object A by the imaging system 6. FIGS. 14A-14B are diagrams illustrating examples of a front surface and a rear surface of a road sign as the inspection target object A.

FIG. 14A illustrates a front surface Af of the inspection target object A. FIG. 14B illustrates a rear surface Ar of the inspection target object A. The inspection target object A includes a sign A1, a pillar part A2, and a fixing member A3. The front surface Af includes the respective front surfaces of the sign A1, the pillar part A2, and the fixing member A3. The rear surface Ar includes the respective rear surfaces of the sign A1, the pillar part A2, and the fixing member A3.

As illustrated in FIG. 11, the imaging device 4 executes imaging in a state of being fixed on the roof of the mobile object 3. With respect to the traveling direction 30, on the roof of the mobile object 3, the forward camera 4F is fixed in the forward direction, the sideward camera 4S is fixed in the sideward direction, and the backward camera 4R is fixed in the backward direction. The imaging device 4 captures images in the respective directions of the forward direction, the sideward direction, and the backward direction while the mobile object 3 is moving.

FIGS. 12A to 12C illustrate images captured by the forward camera 4F during the course of the mobile object 3 approaching the inspection target object A. FIG. 12A illustrates a captured image If1 in a state where the distance from the mobile object 3 to the inspection target object A is long as compared to those in FIGS. 12B and 12C. FIG. 12B illustrates a captured image If2 in a state where the mobile object 3 comes closer to the inspection target object A than in the state in FIG. 12A. FIG. 12C illustrates a captured image If3 in a state where the mobile object 3 comes even closer to the inspection target object A than in the state in FIG. 12B. As illustrated in FIGS. 12A to 12C, as the mobile object 3 comes closer to the inspection target object A, the size of the inspection target object A in the captured image I becomes greater. Note that in the captured images I illustrated in FIGS. 12A-12C, the front surface Af of the inspection target object A is imaged.

The captured image If1 or the captured image If2 corresponds to an example of the image for determination. The captured image If3 corresponds to an example of the reference image for forward inspection or an example of the captured image for forward inspection. The captured image If1, the captured image If2, and the captured image If3 each correspond to an example of a first captured image.

FIG. 13A illustrates a captured image Is of the side surface As of the inspection target object A imaged by the sideward camera 4S. FIG. 13B illustrates a captured image Ir of the rear surface Ar of the inspection target object A imaged by the backward camera 4R. Each of the captured image Ir and the captured image Is corresponds to an example of a second captured image.

The imaging system 6 can obtain the reference image for sideward inspection and the captured image for sideward inspection according to the distance or the like also for the captured image Is by the sideward camera 4S, in substantially the same way as the image If captured by the forward camera 4F. In addition, the imaging system 6 can obtain the reference image for backward inspection and the captured image for backward inspection according to the distance or the like also for the captured image Ir by the backward camera 4R, in substantially the same way as the image If captured by the forward camera 4F.

### <Examples of Management DBs>

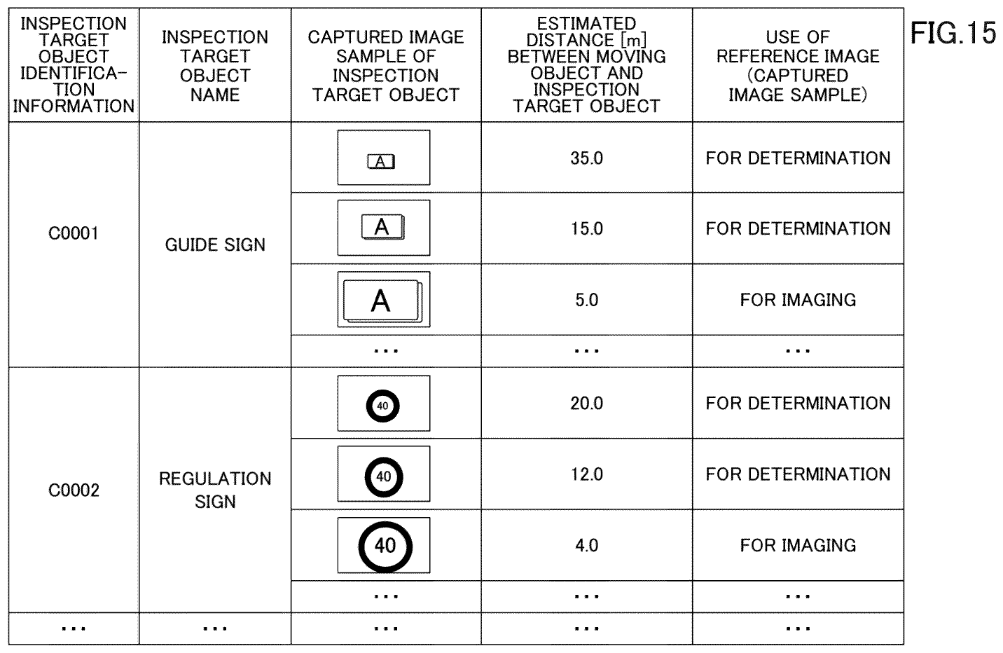

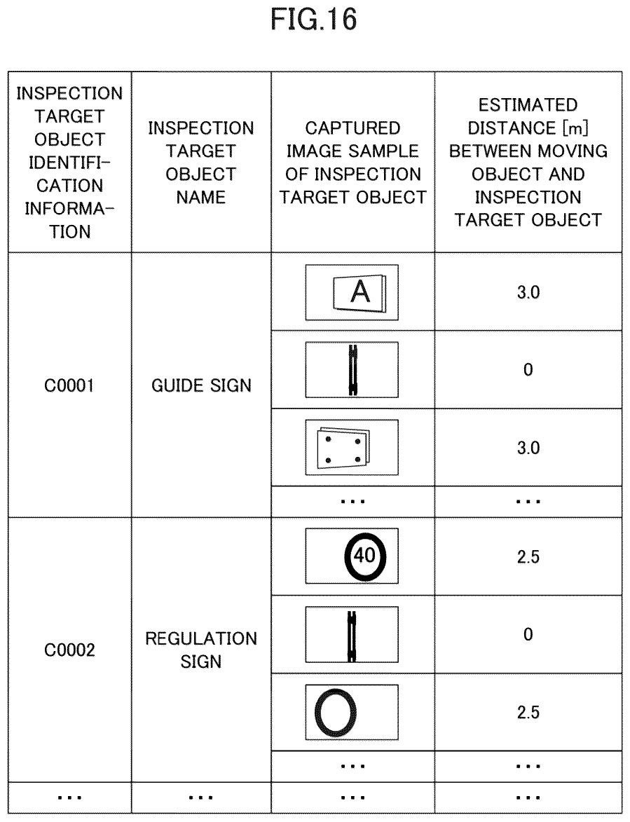

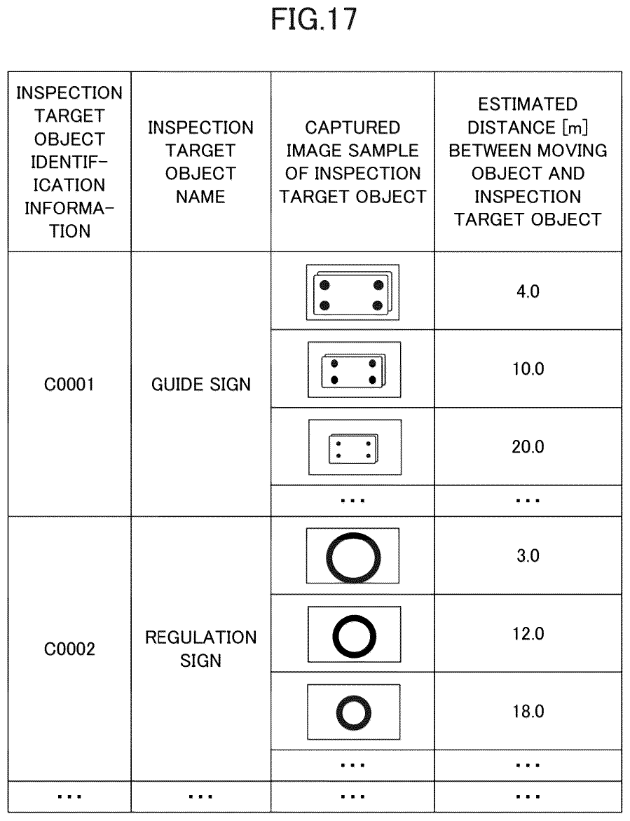

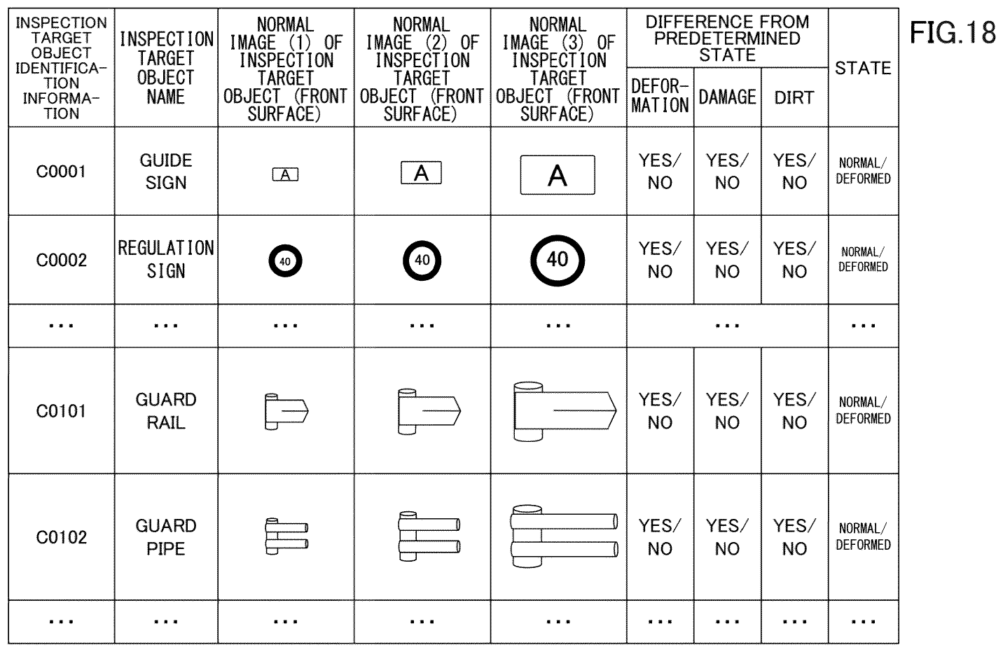

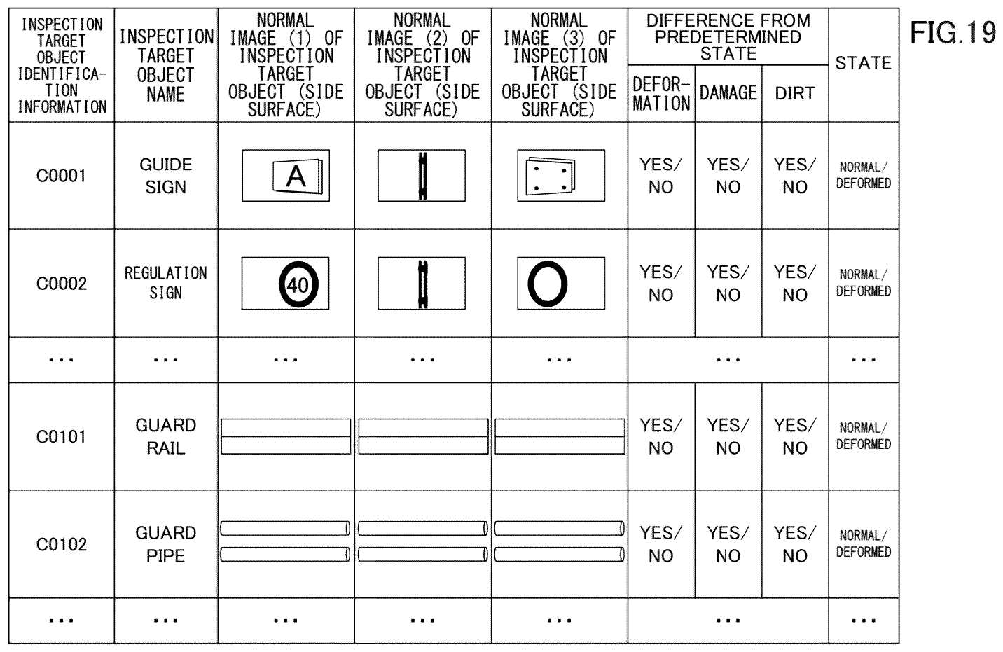

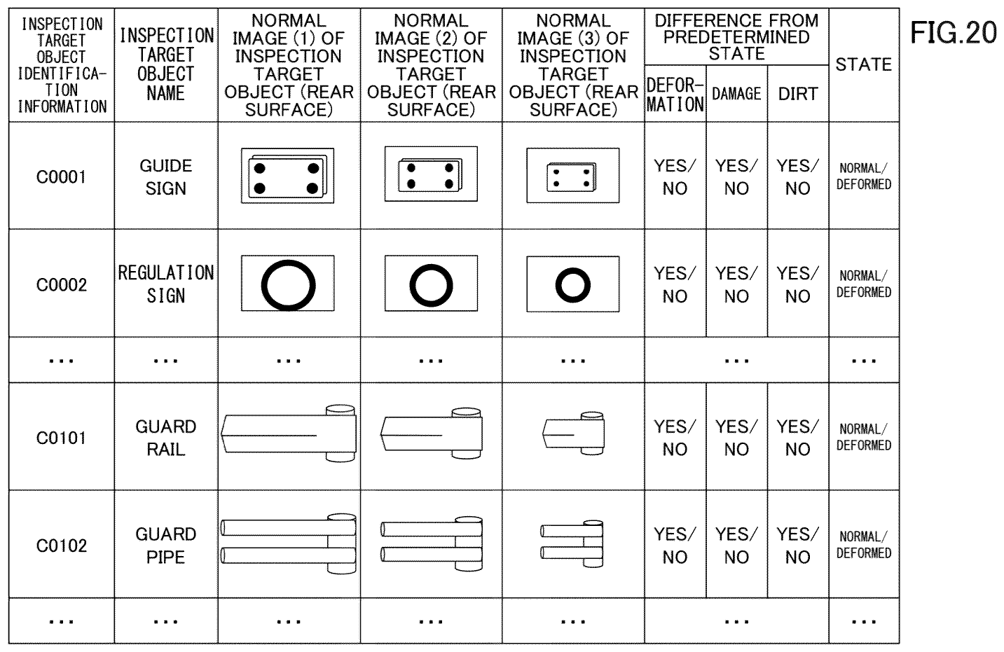

With reference to FIGS. 15 to 20, management DBs stored in the information processing system 1 will be described. FIG. 15 is a diagram illustrating an example of the inspection target object front surface management DB 6011 in the imaging system 6. FIG. 16 is a diagram illustrating an example of the inspection target object side surface management DB 6012 in the imaging system 6. FIG. 17 is a diagram illustrating an example of the inspection target object rear surface management DB 6013 in the imaging system 6. FIG. 18 is a diagram illustrating an example of the front surface deformation state management DB 7011 in the image analysis device 7. FIG. 19 is a diagram illustrating an example of the side surface deformation state management DB 7012 in the image analysis device 7. FIG. 20 is a diagram illustrating an example of the rear surface deformation state management DB 7013 in the image analysis device 7.

The inspection target object front surface management DB 6011 illustrated in FIG. 15 accumulates information on the front surfaces of various inspection target objects A. The inspection target object side surface management DB 6012 illustrated in FIG. 16 accumulates information on the side surfaces of various inspection target objects A. The inspection target object rear surface management DB 6013 illustrated in FIG. 17 accumulates information on the rear surfaces of various inspection target objects A. FIGS. 15 to 17 illustrate, from the leftmost column to the right column in the figures, inspection target object identification information, inspection target object name, captured image sample of the inspection target object A, and estimated distance between the mobile object 3 and the inspection target object A. In FIG. 15, the use of each captured image sample as a reference image is listed in a column further to the right of the column of estimated distance between the mobile object 3 and the inspection target object A.

The inspection target object identification information is information used for identifying an inspection target object A. For example, a code having arbitrary alphanumeric characters is used for the inspection target object identification information. The inspection target object name is information indicating classification of the inspection target object. As the inspection target object name, names that indicate classification of the inspection target objects A such as guide sign, regulation sign, and the like may be enumerated. The captured image sample of the inspection target object is used as a reference training image in the DNN. The estimated distance between the mobile object 3 and the inspection target object A is a distance detected by the image analysis unit 67 illustrated in FIG. 7 when the captured image sample of the inspection target object A is obtained. As the use of the reference image, “for determination”, “for imaging”, and the like described above may be enumerated.

The front surface deformation state management DB 7011 illustrated in FIG. 18 accumulates information on the state of the front surface of various inspection target objects A. The side surface deformation state management DB 7012 illustrated in FIG. 19 accumulates information on the state of the side surface of various inspection target objects A. The rear surface deformation state management DB 7013 illustrated in FIG. 20 accumulates information on the state of the rear surface of various inspection target objects A. FIGS. 18 to 20 illustrate, from the leftmost column to the right column in the figures, inspection target object identification information, inspection target object name, normal image (1), image (2), and image (3) of the inspection target object A, differences from the predetermined state, and the state.

The inspection target object identification information and the inspection target object name are the same as those illustrated in FIGS. 15 to 17. The normal image (1), image (2), and image (3) of the inspection target object A are images of the inspection target object A in three normal states. The differences from the predetermined state indicate presence or absence of each of deformation, damage, and dirt of the inspection target object A with respect to the predetermined state. The state indicates whether the state of the inspection target object A is normal or deformed.

### <Examples of Operations of Information Processing System 1>

### (Example of Overall Operations of Information Processing System 1)

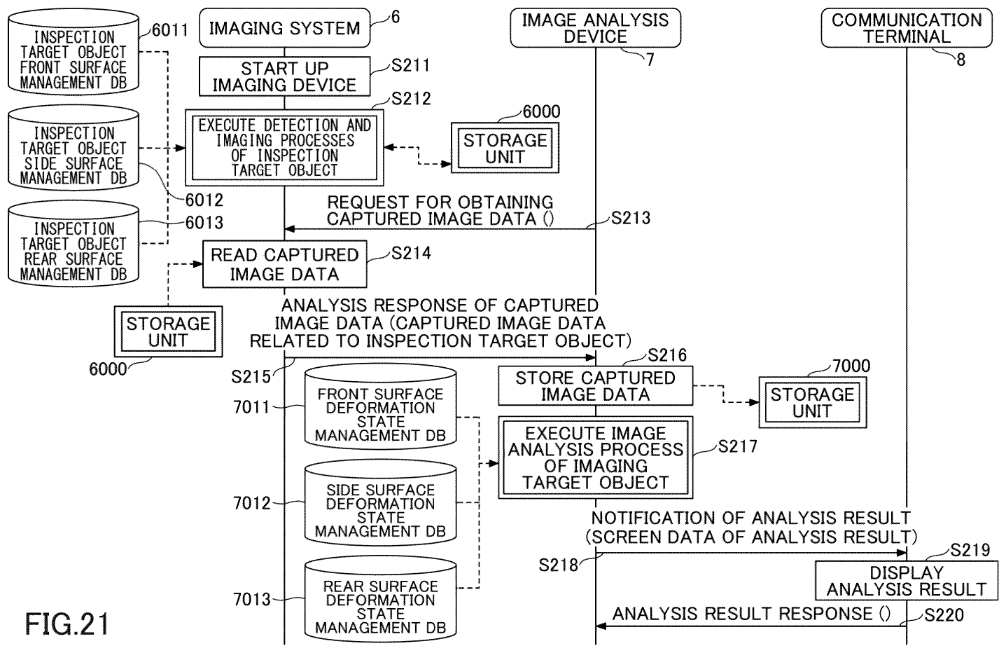

FIG. 21 is a sequence chart illustrating an example of overall operations of the information processing system 1.

First, at Step S211, the imaging system 6 starts up the imaging device 4.

Next, at Step S212, the imaging system 6 executes detection and imaging processes of the imaging target object A by the determination unit 65. At this time, the imaging system 6 executes the detection and imaging processes by referring to the inspection target object front surface management DB 6011, the inspection target object side surface management DB 6012, and the inspection target object rear surface management DB 6013. After executing the detection and imaging processes, the imaging system 6 stores the results in the storage unit 6000.

Next, at Step S213, the image analysis device 7 requests the imaging system 6 to obtain captured image data.

Next, at Step S214, in response to the request from the image analysis device 7, the imaging system 6 reads captured image data from the storage unit 6000.

Next, at Step S215, the imaging system 6 transmits the captured image data related to the inspection target object A to the image analysis device 7, and transmits an analysis response of the captured image data to the image analysis device 7.

Next, at Step S216, the image analysis device 7 stores the captured image data received from the imaging system 6 in the storage unit 7000.

Next, at Step S217, the image analysis device 7 refers to the front surface deformation state management DB 7011, the side surface deformation state management DB 7012, and the rear surface deformation state management DB 7013 by the determination unit 75, and executes a detection process of damage to the inspection target object A as an image analysis process.

Next, at Step S218, the image analysis device 7 notifies the communication terminal 8 of the analysis result.

Next, at Step S219, the communication terminal 8 displays the analysis result by the image analysis device 7.

Next, at Step S220, the communication terminal 8 transmits the analysis result response to the image analysis device 7.

As described above, the information processing system 1 can execute the process of detecting the inspection target object A and detecting its damage, and display the result on the display 807 or the like of the communication terminal 8.

### (Example Imaging Control Operations by Imaging System 6)

The imaging system 6 mainly executes “detection of an inspection target object” and “imaging of an inspection target object” as imaging control operations. The operations of “detection of an inspection target object” are operations to determine whether an inspection target object appears in an image captured by the forward camera imaging the forward direction of the detected inspection target object. Here, for “detection of an inspection target object”, it is not necessary to use the same imaging device as used for “imaging of an inspection target object”. In addition, there may be a method other than the method of detecting the inspection target object A from an image in which the forward direction of the mobile object 3 is imaged. In other words, “detection of an inspection target object” is not limited to imaging an inspection target object. Here, although an example is described that uses the same imaging device as used in “imaging of an inspection target object” for “detection of an inspection target object”, specifically, the forward camera 4F for imaging the front surface of an inspection target object A, this is merely an example.

Under control of the imaging control device 5, the operation mode of the imaging control device 5 includes a “detection mode” for detecting an inspection target object A and an “imaging mode” for imaging the inspection target object. These two operation modes are exclusive in the examples illustrated in the present specification, and the operations are executed in the “detection mode” at the initial stage when the mobile object 3 starts moving, and in the “imaging mode” once detecting the inspection target object A. Once imaging of the detected inspection target object A is completed, the operation returns to the “detection mode”.

FIG. 22 is a flow chart illustrating an example of the imaging control operations of the imaging system 6. The imaging system 6 starts the imaging control operations illustrated in FIG. 22 in the case where the operation reception unit 62 receives a start command of the imaging control operations. Note that it may be configured to automatically start the imaging control operations when the mobile object 3 starts moving.

First, at Step S221, the imaging system 6 determines whether an imaging operation of the inspection target object is in progress.

If it is determined at Step S221 that an imaging operation is in progress (YES at Step S221), the imaging system 6 executes or continues the imaging process of the inspection target object A at Step S223. On the other hand, if it is determined that an imaging operation is not in progress (NO at Step S221), the imaging system 6 executes a detection process of the inspection target object A at Step S222.

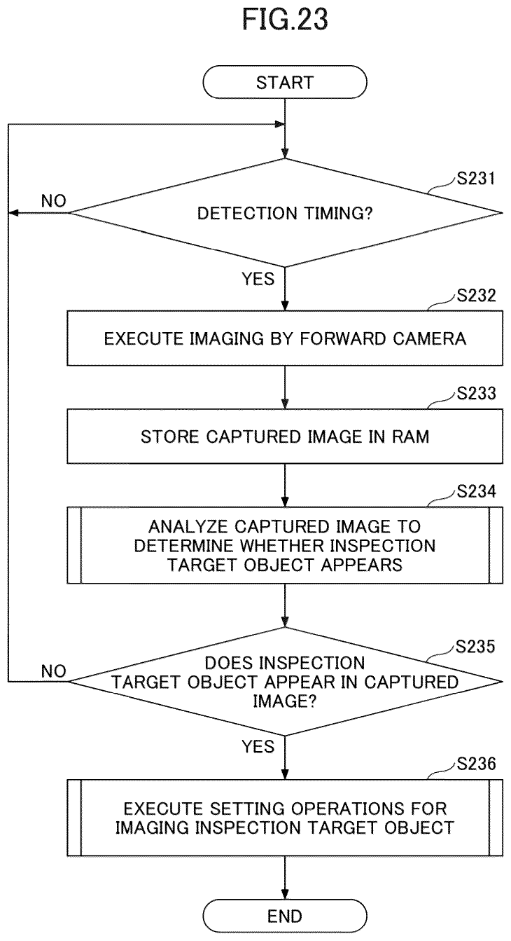

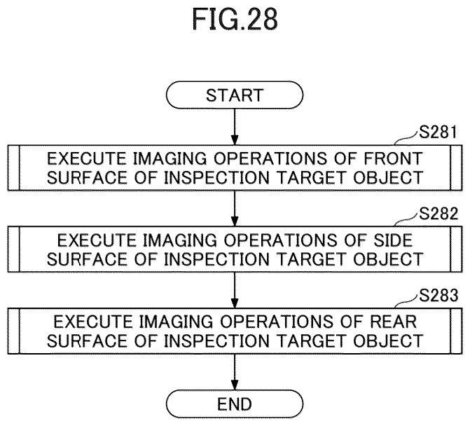

Flow charts of detailed processing at Step S222 or a “process of detecting a target object to be inspected” are illustrated in FIGS. 23 to 27. In addition, flow charts of detailed processing at Step S223 or a “process of imaging a target object to be inspected” are illustrated in FIGS. 28 to 31. As described above, the operation mode of the imaging control device 5 is the “detection mode” at the initial stage when the mobile object 3 starts moving. As will be described later, once detecting an inspection target object, the imaging system 6 sets the imaging timing of each of the forward camera 4F, the sideward camera 4S, and the backward camera 4R, and sets the operation mode of the imaging control device 5 to the “imaging mode”. Similarly, as will be described later, in the case where it is determined that the imaging operations of the inspection target object A by the backward camera 4R are finished, the imaging system 6 sets the operation mode of the imaging control device 5 to the “detection mode”.

### (Example Detection Operations of Imaging System 6)

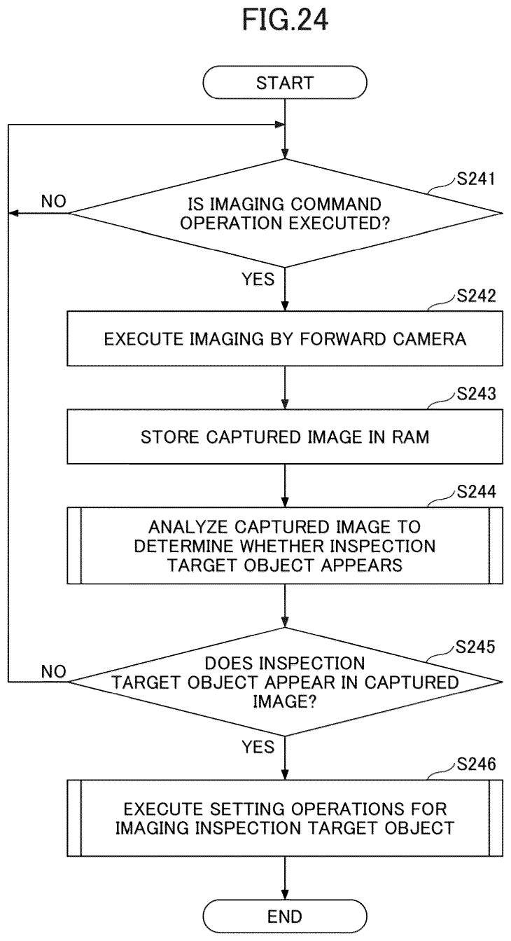

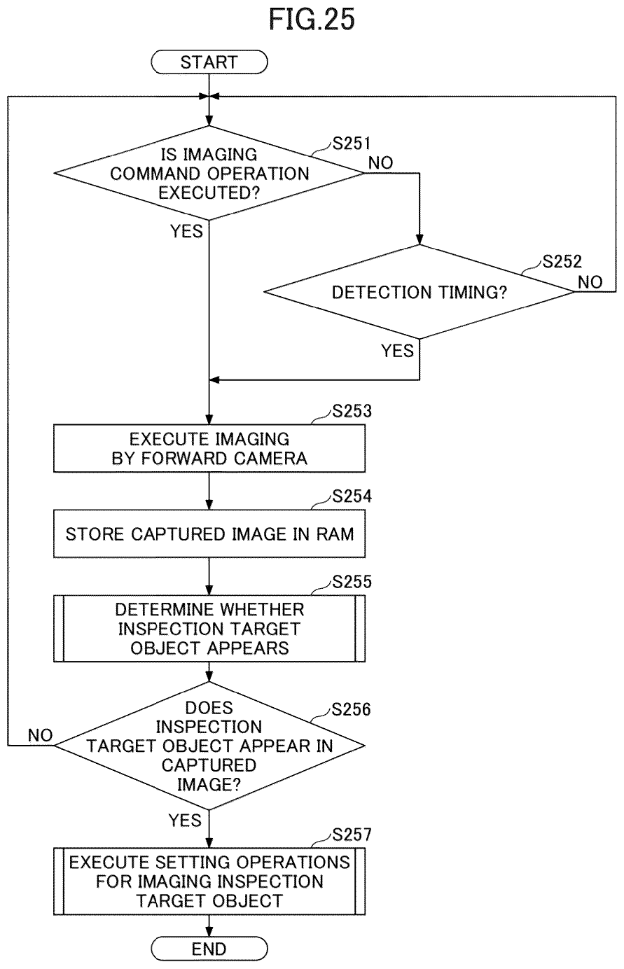

Two cases can be considered upon executing the detection operations of an inspection target object, i.e., a case of executing automatically, and a case of executing manually by an operator of the imaging system 6. FIG. 23 is a flow chart illustrating an example of automatic detection operations executed by the imaging system 6. Specifically, the automatic detection operations include operations to execute imaging by the forward camera 4F at predetermined time intervals based on the moving speed of the mobile object 3, analyze the captured image, and the like. FIG. 24 is a flow chart illustrating an example of manual detection operations executed by the imaging system 6. Specifically, the manual detection operations include operations to execute imaging by the forward camera 4F based on an operation of the operator of the imaging system 6, analyze the captured image, and the like. FIG. 25 is a flow chart illustrating an example of automatic and manual detection operations executed by the imaging system 6. The automatic and manual detection operations execute both the automatic and manual detection operations.

In the analysis of the captured image for detecting an inspection target object, it is determined whether a subject as a candidate for the inspection target object A appears in the image plane of the captured image. Whether or not the subject as a candidate for the inspection target object A appears in the image plane of the captured image can be determined using a known image analysis process (see, for example, Patent Document 1).

In the case where a subject as a candidate for the inspection target object A appears in the image plane, whether the subject is the inspection target object A is determined. This determination is made using a reference image (image for determination) for determining whether the subject is the inspection target object A. The determination of whether the subject is the inspection target object A is made in a state where the distance from the mobile object 3 to the subject is further than in the imaging for inspection. In other words, the size of the subject (a candidate of the inspection target object A) in in the image plane is smaller than the subject (the inspection target object A) in the image plane by the imaging for inspection. Therefore, the reference image (image for determination) for determining whether it is the inspection target object A is a different image from the “reference image for imaging” used for imaging determination of the inspection image.

As described above, the reference image (image for determination) for determining whether it is the inspection target object A is, for example, the captured image If1 in FIG. 12A or the captured image If2 in FIG. 12B. As described above, the reference image for imaging used for imaging determination of the inspection image is, for example, the captured image If3 in FIG. 12C.

In the case where it is determined that a candidate of an inspection target object in the image plane is the inspection target object A, the imaging system 6 determines the inspection target object A to be captured, and sets the “reference image for imaging” of the inspection target object A determined as the “reference image for imaging”. In the case where it is determined that a candidate of an inspection target object in the image plane is the inspection target object A, the imaging system 6 executes a setting process for capturing the inspection target object A.

The imaging start timing is calculated based on the imaging position of the image at which whether the candidate of the inspection target object in the image plane is the inspection target object A is determined; the moving speed of the mobile object 3; and the like. The imaging start timing corresponds to the imaging start timing of each of the forward camera 4F, the sideward camera 4S, and the backward camera 4R.

In calculation of the imaging start timing, a ratio of the size (range in the image plane) of the inspection target object A in the image plane with which it is determined whether the candidate inspection target object in the image is the inspection target object A, to the size (range in the image plane) of the inspection target object A in the “reference image for imaging” used for imaging determination of the inspection image is calculated. From this ratio, the distance from the imaging position of the image with which it is determined whether a candidate of the inspection target object A is captured, to the imaging start position is calculated, and the imaging start timing is calculated based on the moving speed of the mobile object 3.

Note that in the imaging of the inspection image, multiple images are captured in the vicinity (forward and backward) of the “reference image for imaging” used for imaging the inspection image. As the reasons for this, the following three points may be enumerated:
(a) It is practically difficult to capture an image completely identical to the “reference image for imaging”.
(b) In order to inspect deformation of the inspection target object A, it is better to use multiple captured images in the vicinity (forward and backward) of the “reference image for imaging to carry out inspection in various aspects.
(c) With respect to a deformed portion of the inspection target object A, in order to generate a partial three-dimensional model (a digital twin of the deformed portion of the inspection target object A), a partial three-dimensional model having a higher accuracy can be generated from a greater number of images in different imaging directions.

For example, at Step S222 in FIG. 22, the imaging system 6 executes one of the operations illustrated in FIGS. 23, 24, and 25, respectively.

### (Automatic Detection Operations)

FIG. 23 is a flow chart of automatic detection operations. In the operations illustrated in FIG. 23, first, at Step S231, the imaging system 6 determines whether it is a detection timing.

If it is determined at Step S231 that it is not a detection timing (NO at Step S231), the imaging system 6 executes the operation at Step S231 again. On the other hand, if it is determined that it is a detection timing (YES at Step S231), at Step S232, the imaging system 6 executes imaging by the forward camera 4F.

Next, at Step S233, the imaging system 6 stores the captured image in the RAM 503 or the like in FIG. 3.

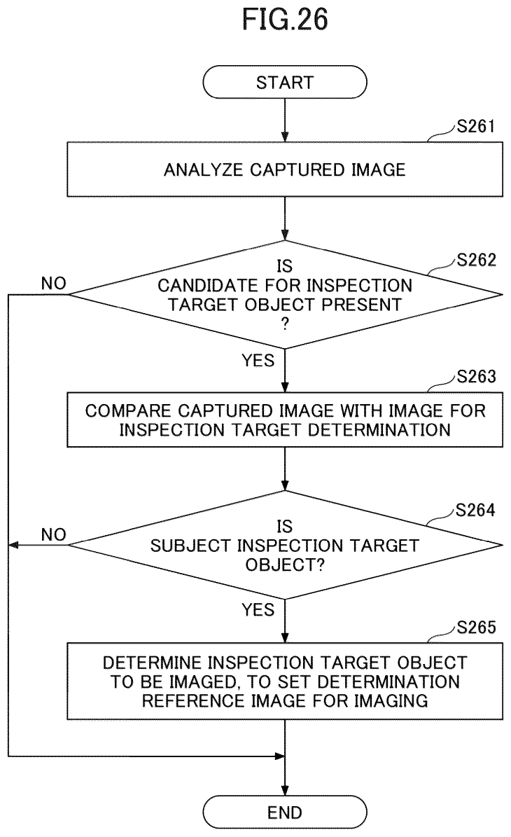

Next, at Step S234, the imaging system 6 executes analysis operations of the captured image, i.e., operations to determine whether the inspection target object A appears in the captured image. The operations at Step S234 will be described later in detail using a flow chart illustrated in FIG. 26.

Next, at Step S235, the imaging system 6 determines whether the inspection target object A appears in the captured image.

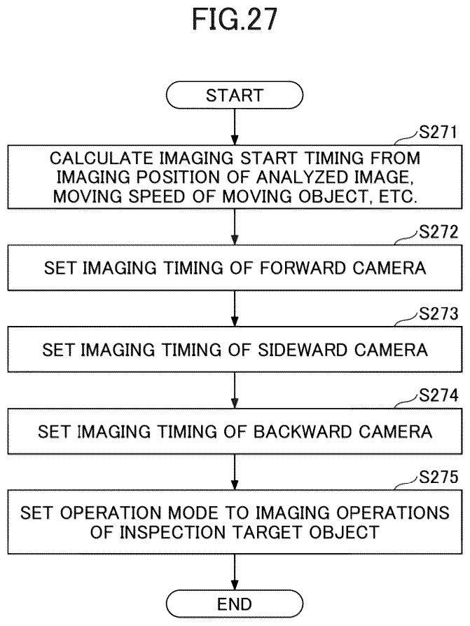

If it is determined at Step S235 that the inspection target object A does not appear in the captured image (NO at Step S235), the imaging system 6 executes the operations at Step S231 and thereafter again. On the other hand, if it is determined that the inspection target object A appears in the captured image (YES at Step S235), at Step S236, the imaging system 6 executes setting operations for imaging the inspection target object A. The operations at Step S236 will be described later in detail using a flow chart illustrated in FIG. 27.

As above, the imaging system 6 can execute the automatic detection operations.

### (Manual Detection Operations)

FIG. 24 is a flow chart of manual detection operations. In the operations illustrated in FIG. 24, first, at Step S241, the imaging system 6 determines whether an imaging command operation is performed by the operator of the imaging system 6 via the operation reception unit 62.

If it is determined at Step S241 that an imaging command operation is not executed (NO at Step S241), the imaging system 6 executes the operation at Step S241 again. On the other hand, if it is determined that an imaging command operation is executed (YES at Step S241), the imaging system 6 transitions to an operation at Step S242.

As the operations in the subsequent Steps S242 to S246 are the same as the operations in Steps S232 to S236 in FIG. 23, duplicate descriptions are omitted here.

As above, the imaging system 6 can execute the manual detection operations.

### (Automatic and Manual Detection Operations)

FIG. 25 is a flow chart of automatic and manual detection operations. In other words, this is a flow chart describing operations in the case of executing both the automatic detection and manual detection. In the operations illustrated in FIG. 25, first, at Step S251, the imaging system 6 determines whether an imaging command operation is performed by the operator of the imaging system 6 via the operation reception unit 62.

If it is determined at Step S251 that an imaging command operation is not executed (NO at Step S251), at Step S252, the imaging system 6 determines whether it is a detection timing. On the other hand, if it is determined that an imaging command operation is executed (YES at Step S251), the imaging system 6 transitions to an operation at Step S253.

If it is determined at Step S252 that it is not a detection timing (NO at Step S252), the imaging system 6 executes the operation at Step S251 again. On the other hand, if it is determined as a detection timing (YES at Step S251), the imaging system 6 transitions to an operation at Step S253.

As the operations in the subsequent Steps S253 to S257 are the same as the operations in Steps S232 to S236 in FIG. 23, duplicate descriptions are omitted here.

As above, the imaging system 6 can execute the automatic and manual detection operations.

### ((Captured Image Analysis Operations))

FIG. 26 is a flow chart illustrating an example of captured image analysis operations executed by the imaging system 6 for detecting an inspection target object, which illustrates in detail the operations for determining whether the inspection target object A appears in the captured image illustrated at Step S234 in FIG. 23, Step S244 in FIG. 24, and Step S255 in FIG. 25. The imaging system 6 executes the operations in FIG. 26 at one of Step S234 in FIG. 23, Step S244 in FIG. 24, and Step S255 in FIG. 25.

First, at Step S261, the imaging system 6 analyzes the captured image.

Next, at Step S262, the imaging system 6 determines whether a subject as a candidate for the inspection target object A is present in the captured image.

If it is determined at Step S262 that a subject is not present (NO at Step S262), the imaging system 6 terminates the operations. On the other hand, if it is determined as present (YES at Step S262), at Step S263, the imaging system 6 compares the captured image with the image for the inspection target determination.

Next, at Step S264, the imaging system 6 determines whether the subject present in the captured image is the inspection target object A.

If it is determined at Step S264 that the subject is not the inspection target object A (NO at Step S264), the imaging system 6 terminates the operations. On the other hand, if it is determined that the subject is the inspection target object A (YES at Step S264), at Step S265, the imaging system 6 determines the inspection target object A to be imaged, and sets the determination reference image for imaging.

As described above, the imaging system 6 can execute analysis operations of the captured image.

### ((Captured Image Setting Operations))

FIG. 27 is a flow chart illustrating an example of setting operations for imaging the inspection target object A by the imaging system 6 after the inspection target object is detected, which illustrates in detail the setting operations for imaging the inspection target object A illustrated at Step S236 in FIG. 23, Step S246 in FIG. 24, and Step S256 in FIG. 25. The imaging system 6 executes the operations in FIG. 27 at one of Step S236 in FIG. 23, Step S246 in FIG. 24, and Step S257 in FIG. 25.

First, at Step S271, the imaging system 6 calculates an imaging start timing from the imaging position of the analyzed image and the moving speed of the mobile object 3.

Next, at Step S272, the imaging system 6 sets the imaging timing of the forward camera 4F.

Next, at Step S273, the imaging system 6 sets the imaging timing of the sideward camera 4S.

Next, at Step S274, the imaging system 6 sets the imaging timing of the backward camera 4R.

After calculating the imaging timing of each of the forward camera 4F, the sideward camera 4S, and the backward camera 4R, at Step S275, the imaging system 6 sets the operation mode to imaging operations of the inspection target object A (“imaging mode”).

As described above, the imaging system 6 can execute the setting operations of the captured image.

### (Example of Imaging Operations of Imaging System 6)

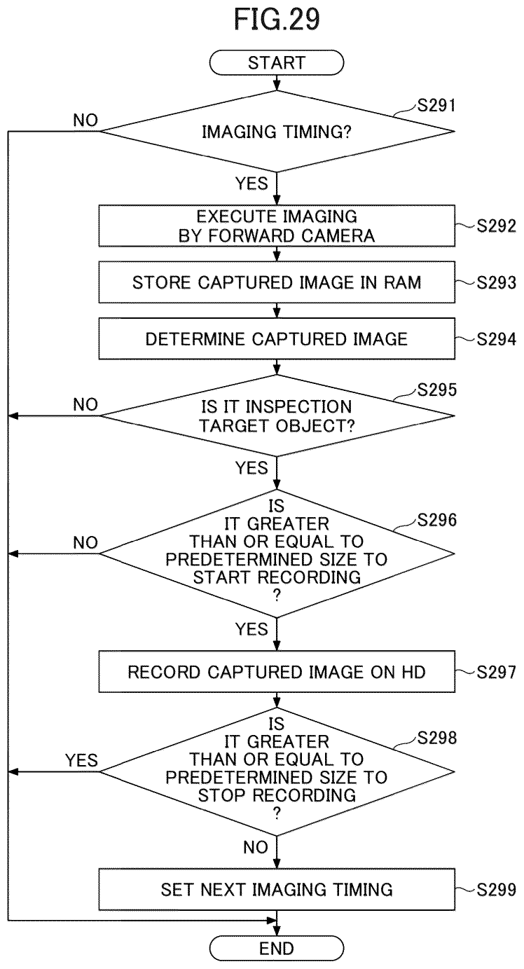

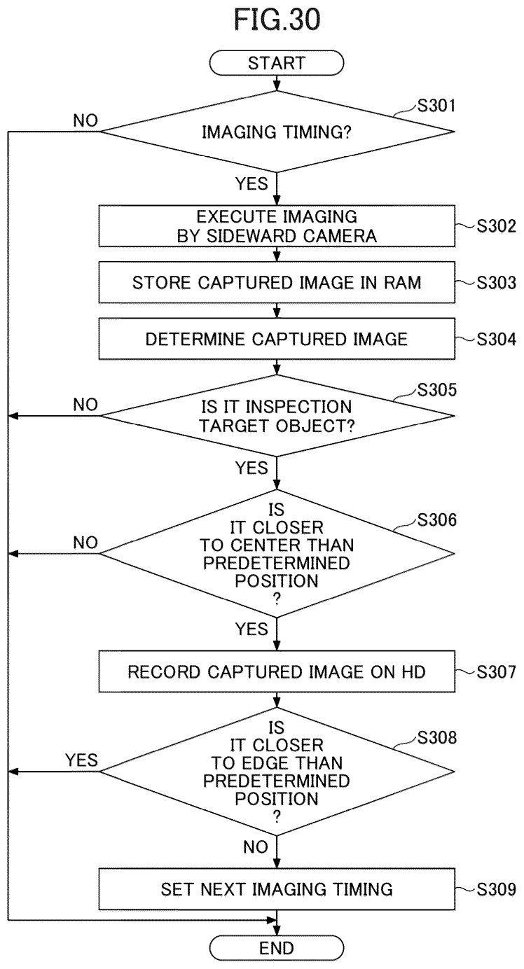

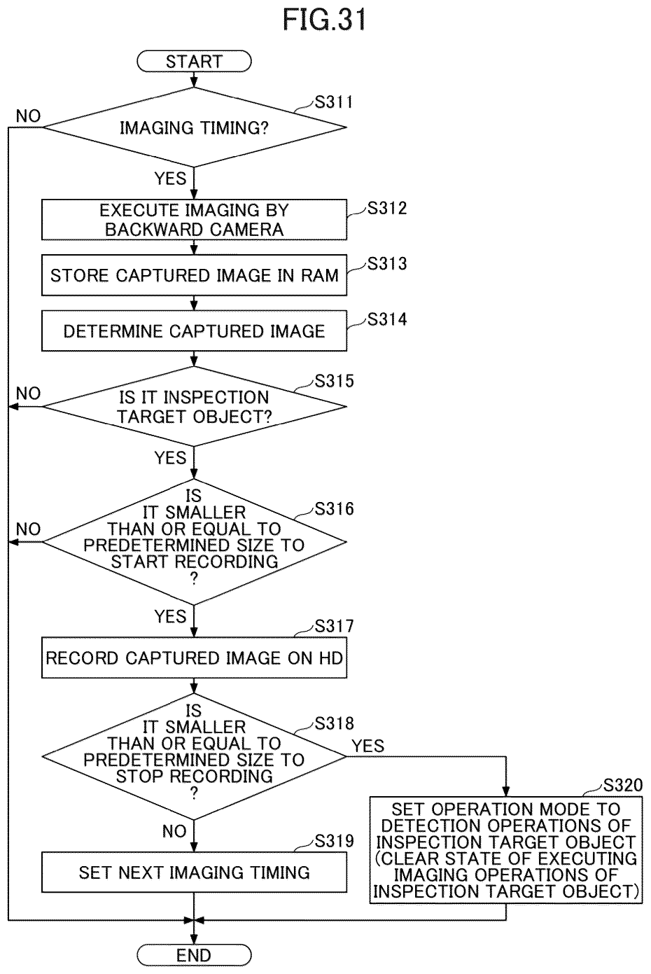

After the inspection target object is detected, the imaging system 6 returns to Step S221 in FIG. 22. As the operation mode is set to the “imaging mode”, it is determined at Step S221 as the imaging operations being executed (YES at Step S221), and the imaging system 6 uses the forward camera 4F, the sideward camera 4S, and the backward camera 4R to image the inspection target object at Step S223. FIG. 28 illustrates details of Step S223 in FIG. 22, and is a flow chart illustrating an example of the overall imaging operations executed by the imaging system 6. FIG. 29 illustrates details of Step S281 in FIG. 28, and is a flow chart illustrating an example of the imaging operations of the front surface of the inspection target object A by the imaging system 6. FIG. 30 illustrates details of Step S282 in FIG. 28, and is a flow chart illustrating an example of the imaging operations of the side surface of the inspection target object A by the imaging system 6. FIG. 31 illustrates details of Step S283 in FIG. 29, and is a flow chart illustrating an example of the imaging operations of the rear surface of the inspection target object A by the imaging system 6.

### ((Overall Imaging Operations))

Upon completion of the inspection target object A detection operations, the imaging system 6 starts the operations illustrated in FIG. 28.

First, at Step S281, the imaging system 6 executes the imaging operations of the front surface of the inspection target object A by the forward camera 4F.

Next, at Step S282, the imaging system 6 executes the imaging operations of the side surface of the inspection target object A by the sideward camera 4S.

Next, at Step S283, the imaging system 6 executes the imaging operations of the rear surface of the inspection target object A by the backward camera 4R.

Considering a possibility that the imaging ranges (angles of view) of the forward camera 4F, the sideward camera 4S, and the backward camera 4R overlap, in the example illustrated in FIG. 28, the imaging system 6 successively executes the imaging operations of the front surface of the inspection target object A, the imaging operations of the side surface of the inspection target object A, and the imaging operations of the rear surface of the inspection target object A. However, each operation illustrated in FIG. 28 terminates at a timing other than the imaging timing; therefore, the imaging in the forward direction (imaging of the front surface), the imaging in the sideward direction (imaging of the side surface), and the imaging in the backward direction (imaging of the rear surface) are not always executed at the same time. The respective imaging timings of the imaging in the forward direction, the imaging in the sideward direction, and the imaging in the backward direction are set based on the moving speed of the mobile object so that the imaging directions of the respective images become appropriately different. If the imaging time interval is too short, the images are captured from almost the same direction, thereby wasting the capacity, whereas if the imaging time interval is too long, the imaging directions are significantly different, thereby preventing highly accurate inspection.

In imaging the inspection target object A, the imaging system 6 determines whether the subject in the captured image is the same image as the detected inspection target object A. Then, upon determining that the subject in the captured image is the same image as the detected inspection target object A, the imaging system 6 determines whether it is an image in the vicinity of the “reference image for imaging” used for imaging determination of the inspection image. In the case of determining that it is an image in the vicinity of the “reference image for imaging”, the imaging system 6 stores the captured image as an inspection image in the HD 505 illustrated in FIG. 4.

In this way, in the imaging operations of the inspection target object A, the imaging system 6 determines whether the subject in the captured image is the same image as the detected inspection target object A, or whether it is an image in the vicinity of the “reference image for imaging”. Accordingly, with regard to the imaging start timing (the timing for starting the first imaging) set in the detection operations of the inspection target object A, the imaging system 6 can provide a margin in the setting of the imaging timing in consideration of the calculation error of the distance from the position where the inspection target object A is detected to the position where the inspection target object A is imaged, and change in the moving speed of the mobile object 3. The margin in the setting of the imaging timing is approximately half to 1/10 of the required imaging time interval.

The subsequent imaging may be set based on the moving speed of the mobile object so as to make the imaging direction of each captured image appropriately different. The method of determining whether the image is in the vicinity of the “reference image for imaging” is different among imaging in the forward direction, imaging in the sideward direction, and imaging in the backward direction.

In the case of imaging the front surface on the mobile object 3 side of the inspection target object A, the imaging system 6 makes a determination using a fact that the inspection target object A in the captured image plane is small at first, and then, becomes larger as the mobile object 3 moves. In the case of imaging the side surface of the mobile object 3 of the inspection target object A, the imaging system 6 makes a determination using a fact that the inspection target object A moves in the horizontal direction in the image plane. In the case of imaging the rear surface of the mobile object 3 side of the inspection target object A, the imaging system 6 makes a determination using a fact that the inspection target object A in the captured image plane is large at first, and then, becomes smaller as the mobile object 3 moves.

The imaging system 6 also determines whether to terminate imaging (imaging operations for inspection images) by using a result of determination whether the image is in the vicinity of the “reference image for imaging”. In the case of continuing the imaging, the imaging system 6 sets the next imaging timing, and terminates the process. In the case of terminating the imaging, the imaging system 6 terminates the process without setting the next imaging timing. Note that in the examples illustrated in FIGS. 29 to 31, it is assumed to execute the imaging in the forward direction, the imaging in the sideward direction, and the imaging in the backward direction, and the imaging in the backward direction is continued even when the imaging in the forward direction and the imaging in the sideward direction are terminated. Then, in the case where it is determined that the imaging is terminated in the imaging operations in the backward direction, the imaging system 6 switches the operation mode to the detection operations of the inspection target object. In other words, the imaging system 6 cancels the operation mode being the imaging mode of the inspection target object. Suppose that the imaging system 6 executes only imaging in the forward direction and imaging in the sideward direction, and does not execute imaging in the backward direction; in this case, the imaging system 6 switches the operation mode from detection of the inspection target object to imaging of the inspection target object when terminating the imaging in the imaging operations in the sideward direction.

### (Imaging Operations of Front Surface)

FIG. 29 is a flow chart of the imaging operations of the front surface. In FIG. 29, the imaging system 6 starts the operations in FIG. 29 at the timing of starting the operation at Step S281 in FIG. 28.

First, at Step S291, the imaging system 6 determines whether it is the imaging timing.

If it is determined at Step S291 that it is not the imaging timing (NO at Step S291), the imaging system 6 terminates the operations. On the other hand, if it is determined that it is the imaging timing (YES at Step S291), at Step S292, the imaging system 6 executes imaging of the front surface of the inspection target object A by the forward camera 4F. In other words, the imaging device 4 obtains a first captured image by imaging the front surface of the inspection target object A.

Next, at Step S293, the imaging system 6 stores the captured image in the RAM 503.

Next, at Step S294, the imaging system 6 executes an operation at Step S295 as a determination operation of the captured image.

Next, at Step S295, the imaging system 6 determines whether the subject is the inspection target object A.

If it is determined at Step S295 that the subject is not the inspection target object A (NO at Step S295), the imaging system 6 terminates the operations. On the other hand, if it is determined that the subject is the inspection target object A (YES at Step S295), at Step S296, the imaging system 6 determines whether the size of the image corresponding to the inspection target object A is greater than or equal to a predetermined size to start recording.

If it is determined at Step S296 that it is not greater than or equal to the size to start recording (NO at Step S296), the imaging system 6 terminates the operations. On the other hand, if it is determined that it is greater than or equal to the size to start recording (YES at Step S296), at Step 3297, the imaging system 6 records the captured image on the HD 505 illustrated in FIG. 4.

Next, at Step S298, the imaging system 6 determines whether the size of the image corresponding to the inspection target object A is greater than or equal to a predetermined size to stop the recording.

If it is determined at Step S298 that the size is greater than or equal to the size to stop the recording (YES at Step S298), next, the imaging system 6 terminates the operations. On the other hand, if it is determined that the size is not greater than or equal to the size to stop the recording (NO at Step S298), at Step S299, the imaging system 6 sets the next imaging timing, and then, terminates the operation.

As described above, the imaging system 6 can execute the imaging operations of the front surface of the inspection target object A.

Examples of the operations to start or stop recording described above are as follows. The same applies to the case in FIG. 31 that will be described later.
When the size becomes 70% or greater with respect to the determination reference image, recording is started.
When the size becomes 130% or greater with respect to the determination reference image, recording is stopped.

In the case where the next imaging is to be executed, the imaging system 6 sets a timer to count the time until the imaging starts. A determination operation of “imaging timing?” first in FIG. 29 determines whether this timer has counted up. The same applies to the case in FIGS. 30 and 31 that will be described later.

### (Imaging Operations of Side Surface)

FIG. 30 is a flow chart of the imaging operations of the side surface. In FIG. 30, the imaging system 6 starts the operations in FIG. 30 at the timing of starting the operation at Step S282 in FIG. 28.

First, at Step S301, the imaging system 6 determines whether it is the imaging timing.

If it is determined at Step S301 that it is not the imaging timing (NO at Step S301), the imaging system 6 terminates the operations. On the other hand, if it is determined that it is the imaging timing (YES at Step S301), at Step S302, the imaging system 6 executes imaging of the side surface of the inspection target object A by the sideward camera 4S. In other words, the imaging control device 5 in the imaging system 6 controls operations of the imaging device 4 to image the side surface of the inspection target object A so as to obtain a second captured image.

As the operations at Steps S303 to S307 are the same as the operations at Steps S293 to S297 in FIG. 29, duplicate descriptions are omitted here.

Next, at Step S308, the imaging system 6 determines whether an edge of an image corresponding to the inspection target object A is closer to an edge of the captured image than a predetermined position.

If it is determined at Step S308 as being closer to the edge (YES at Step S308), the imaging system 6 executes the operations at Step S301 and thereafter again. On the other hand, if it is determined as not being closer to the edge (NO at Step S308), at Step S309, the imaging system 6 sets the next imaging timing, and then, terminates the operation.

As described above, the imaging system 6 can execute the imaging operations of the side surface of the inspection target object A.

Here, examples of the operations to start or stop recording are as follows.
With reference to the position of the inspection target object in the determination reference image, start recording when the position comes to a predetermined position from one edge.
With reference to the position of the inspection target object in the determination reference image, stop recording the position comes to a predetermined position from the other edge.

### (Imaging Operations of Rear Surface)

FIG. 31 is a flow chart of the imaging operations of the rear surface. In FIG. 31, the imaging system 6 starts the operations in FIG. 31 at the timing of starting the operation at Step S283 in FIG. 28.

First, at Step S311, the imaging system 6 determines whether it is the imaging timing.

If it is determined at Step S311 that it is not the imaging timing (NO at Step S311), the imaging system 6 terminates the operations. On the other hand, if it is determined that it is the imaging timing (YES at Step S311), at Step S312, the imaging system 6 executes imaging of the rear surface of the inspection target object A by the backward camera 4R. In other words, the imaging control device 5 in the imaging system 6 controls operations of the imaging device 4 to image the rear surface of the inspection target object A so as to obtain a second captured image.

As the operations at Steps S313 to S319 are the same as the operations at Steps S293 to S299 in FIG. 29, duplicate descriptions are omitted here.

If it is determined at Step S318 that the size is greater than or equal to the size to stop recording (YES at Step S318), the imaging system 6 sets the operation mode to the detection operations (“detection mode”) of the inspection target object A, and clears the state of executing the imaging operation of the inspection target object A in the operation mode (Step S320). Thereafter, the imaging system 6 returns to Step S221 in FIG. 22. As the operation mode is set to the “detection mode”, it is determined at Step S221 that an imaging operation is not being executed (NO at Step S221), and the imaging system 6 executes the detection process of the inspection target object A at Step S222.

As described above, the imaging system 6 can execute the imaging operations of the rear surface of the inspection target object A.

### <Example of Imaging Timing by Imaging System 6>

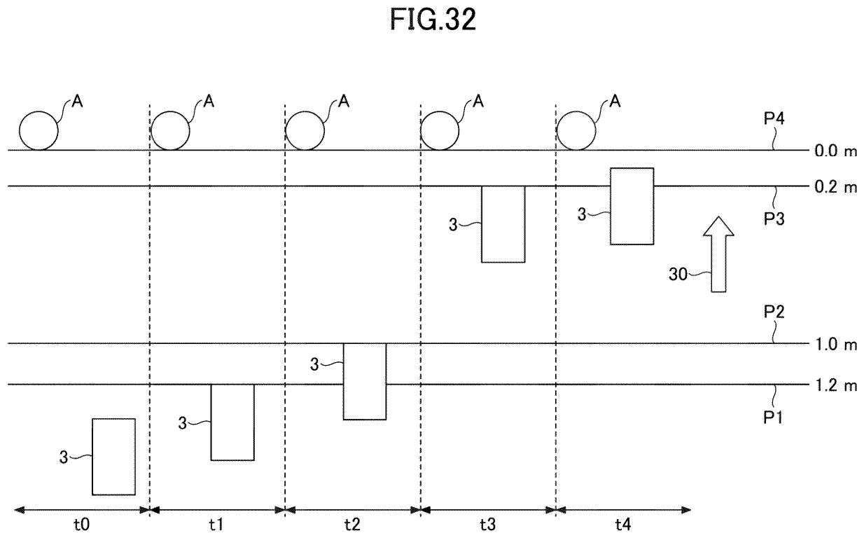

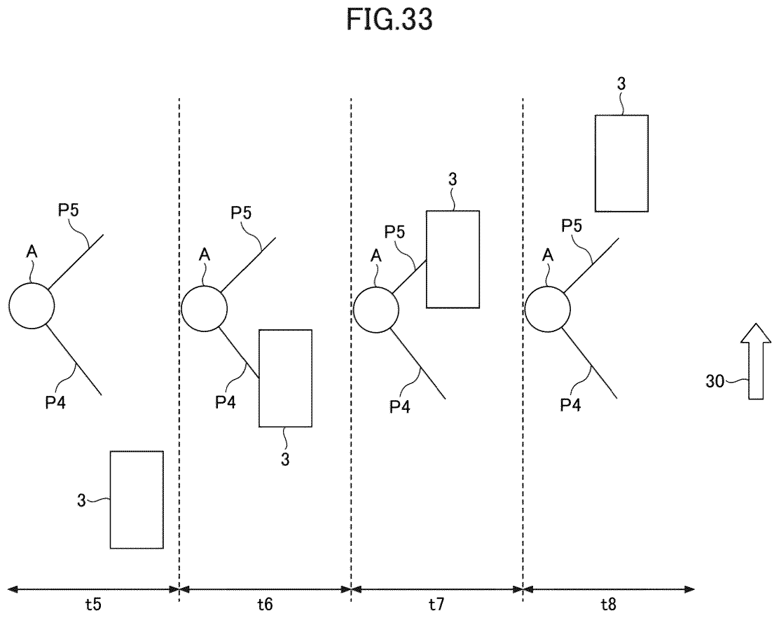

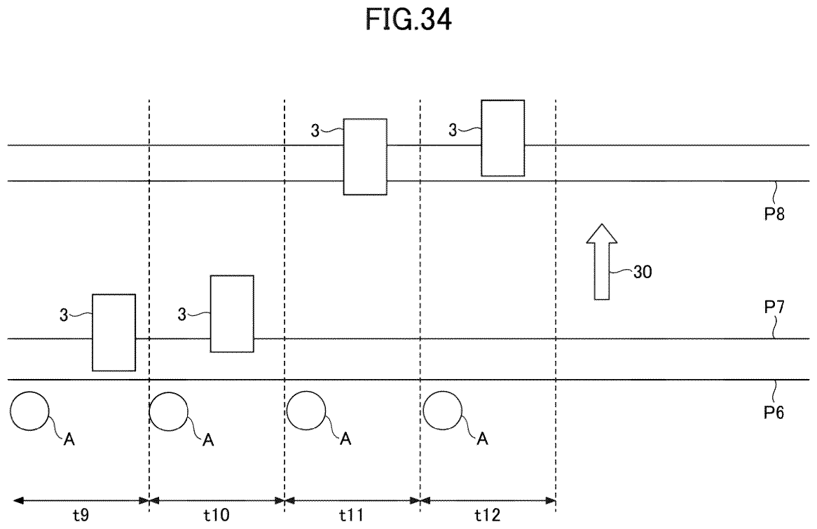

With reference to FIGS. 32 to 34, imaging timing by the imaging system 6 will be described. FIG. 32 is a diagram illustrating an example of imaging timing of the front surface of the inspection target object A by the imaging system 6. FIG. 33 is a diagram illustrating an example of imaging timing of the side surface of the inspection target object A by the imaging system 6. FIG. 34 is a diagram illustrating an example of imaging timing of the rear surface of the inspection target object A by the imaging system 6.

FIG. 32 illustrates positions of the mobile object 3 having the imaging system 6 installed and moving in the traveling direction 30 relative to the inspection target object A at the respective timings t0 to t4. The timing t0 represents a timing before determination by the imaging system 6. The timing t1 represents a timing to make determination by the imaging system 6. The timing t2 represents a timing to start imaging of the front surface of the inspection target object A by the imaging system 6. This timing t2 is an example of a first timing. The timing t3 represents a timing to stop the imaging of the front surface of the inspection target object A by the imaging system 6. The timing t4 represents a timing to stop the imaging operations of the front surface of the inspection target object A by the imaging system 6.

The position P1 represents a position of the mobile object 3 at the timing t1. The position P2 represents a position of the mobile object 3 at the timing t2. The position P3 represents a position of the mobile object 3 at the timing t3. The position P4 represents a position of the inspection target object A.

The distance between the mobile object 3 and the inspection target object A at the position P1 is, for example, 1.2 m. The distance between the mobile object 3 and the inspection target object A at the position P2 is, for example, 1.0 m. The distance between the mobile object 3 and the inspection target object A at the position P3 is, for example, 0.2 m. Note that the distance here means a minimum distance between the front surface of the inspection target object A and the imaging surface of the forward camera 4F.

FIG. 33 illustrates positions of the mobile object 3 having the imaging system 6 installed and moving in the traveling direction 30 relative to the inspection target object A at the respective timings t5 to t8. The timing t5 represents a timing before starting imaging operations of the side surface of the inspection target object A by the imaging system 6. The timing t6 represents a timing to start imaging of the side surface of the inspection target object A by the imaging system 6. This timing t6 is an example of a second timing. The timing t7 represents a timing to stop the imaging of the side surface of the inspection target object A by the imaging system 6. The timing t8 represents a timing to stop the imaging operations of the side surface of the inspection target object A by the imaging system 6.

The position P4 represents a position to start the imaging of the side surface of the inspection target object A by the imaging system 6. The position P5 represents a position to stop the imaging of the side surface of the inspection target object A by the imaging system 6. Note that the distance here means a minimum distance between the side surface of the inspection target object A and the imaging surface of the sideward camera 4S.

FIG. 34 illustrates positions of the mobile object 3 having the imaging system 6 installed and moving in the traveling direction 30 relative to the inspection target object A at the respective timings t9 to t12. The timing t9 represents a timing before starting imaging operations of the rear surface of the inspection target object A by the imaging system 6. The timing t10 represents a timing to start imaging of the rear surface of the inspection target object A by the imaging system 6. This timing t10 is an example of a second timing. The timing t1l represents a timing to stop the imaging of the rear surface of the inspection target object A by the imaging system 6. The timing t12 represents a timing to stop the imaging operations of the rear surface of the inspection target object A by the imaging system 6.

The position P6 represents a position of the inspection target object A. The position P7 represents a position of the mobile object 3 at the timing t10. The position P8 represents a position of the mobile object 3 at the timing t1l.

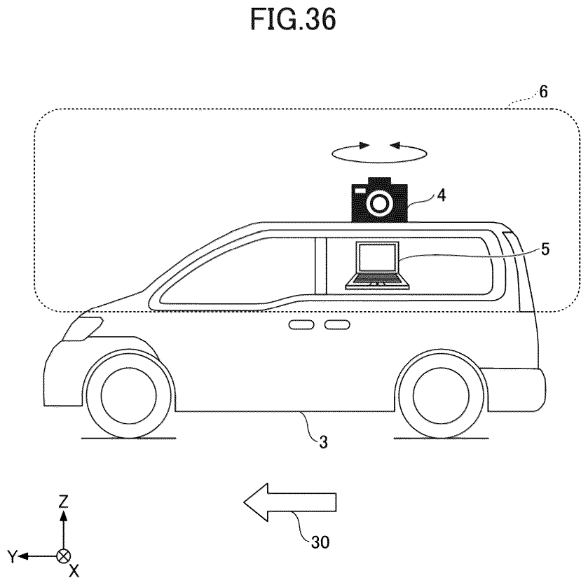

In the embodiment described above, although it has been described that an inspection target object is imaged by using three cameras (the forward camera 4F, the sideward camera 4S, and the backward camera 4R), the inspection target object may be imaged by a single camera changing its orientation (imaging direction) as illustrated schematically in FIG. 36.

### <Display Example of Inspection Result Screen by Information Processing System 1>

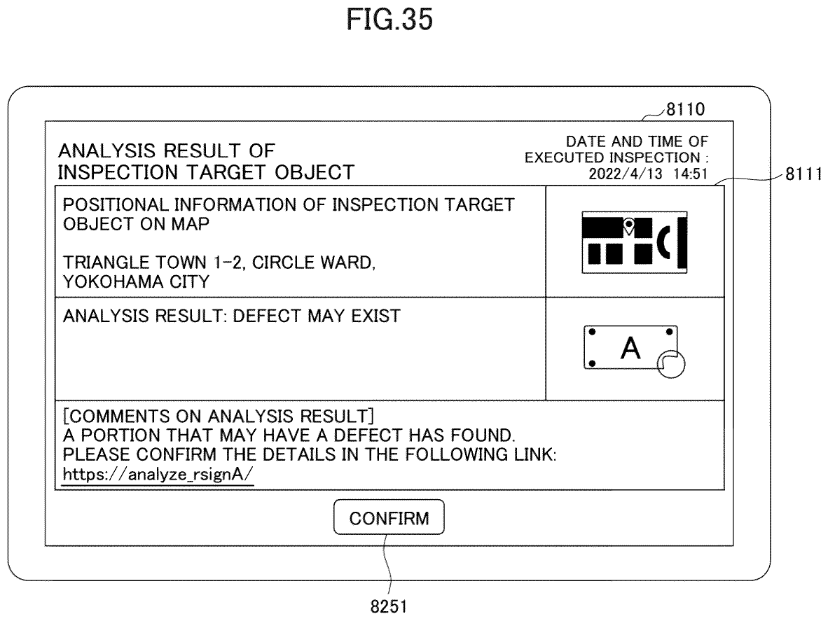

FIG. 35 is a diagram illustrating an example of display of an inspection result screen by the information processing system 1. A screen 8110 shows an inspection result screen by the information processing system 1. The screen 8110 is displayed on the display 807 or the like of the communication terminal 8 illustrated in FIG. 8. However, the screen 8110 may be displayed on the display 407 of the imaging device 4 illustrated in FIG. 3, the display 507 of the imaging control device 5 illustrated in FIG. 4, the display 707 of the image analysis device 7 illustrated in FIG. 5, or any other display being an external device.

A table 8111 shows information on detailed inspection results such as positional information on the inspection target object on a map, map information on the inspection target object, presence or absence of a defect on the inspection target object A, an image showing a defect on the inspection target object A, and comments indicating the analysis result. The button 8251 is a UI (User Interface) part operated by an observer of the screen 8110 in the case where the observer confirms the inspection results.

### <Operations and Effects of Imaging System 6 and Information Processing System 1>

As described above, the imaging system 6 according to the present embodiment includes the imaging device 4 and the imaging control device 5 to control operations of the imaging device 4. The imaging device 4 is installed on the mobile object 3 to image an inspection target object A while the mobile object 3 is moving. A side visible from the imaging device 4 when the inspection target object A is positioned in the forward direction with respect to the traveling direction 30 of the mobile object 3 is defined as the front surface Af of the inspection target object A; a side visible from the imaging device 4 when the mobile object 3 is positioned in the sideward direction with respect to the traveling direction 30 is defined as the side surface As of the inspection target object A; and a side visible from the imaging device 4 when the mobile object 3 is positioned in the backward direction with respect to the traveling direction 30 is defined as the rear surface Ar of the inspection target object A. The imaging device 4 images the front surface of the inspection target object A at a first timing when the inspection target object A is positioned in the forward direction with respect to the traveling direction 30, to obtain a first captured image. The imaging control device 5 controls operations of the imaging device, to obtain a second captured image by imaging at least one of the side surface or the rear surface of the inspection target object A, at a second timing when the inspection target object A is positioned in at least one of the sideward direction or the backward direction with respect to the traveling direction 30. In the present embodiment, thanks to using the forward camera 4F, the sideward camera 4S and the backward camera 4R, multiple captured images of the inspection target object captured from different directions at multiple viewpoints can be obtained.

In addition, in the present embodiment, the information processing system 1 inspects the inspection target object A using the imaging system 6. Accordingly, multiple captured images captured from different directions at multiple viewpoints can be obtained that are useful for three-dimensional inspection of the inspection target object A in various viewpoints. The multiple captured images captured from the different directions at the multiple viewpoints are analyzed, and hence, the information processing system 1 can three-dimensionally inspect the inspection target object in the various viewpoints. In addition, the information processing system 1 prepares an imaging reference image for capturing an image that is easily compared with an inspection reference image, and executes imaging control based on the imaging reference image, and hence, the image used for inspection can be efficiently captured. By preparing the inspection reference image that is compatible with the obtainment method of the inspection image, and capturing the inspection image that is easily compared with the inspection reference image, inspection can be executed efficiently.

In addition, the imaging system 6 includes the target object detection unit 90 that detects the inspection target object A based on at least one of the first captured image or the second captured image; the damage detection unit 92 that detects damage to the inspection target object A based on at least one of the first captured image or the second captured image; and the display control unit 84 that displays a detection result of the damage. With this configuration, the detection result of the damage to the inspection target object A can be displayed on the display 807 of the communication terminal 8 or the like, and thereby, an operator of the communication terminal 8 or the like can easily recognize the inspection result of the inspection target object A.

In addition, in the present embodiment, the inspection target object A includes a sign A1, a pillar part A2 supporting the sign A1, and a fixing member A3 fixing the sign A1 to the pillar part A2. The damage detection unit 92 may detect at least one of deformation from the predetermined shape of the sign A1, deformation of the pillar part A2, or loosening of the fixing member A3, based on at least one of the first captured image or the second captured image. Accordingly, on the inspection target object A including the sign A1 of a road sign or the like fixed to the pillar part A2 by the fixing member A3, each of the sign A1, the pillar part A2, and the fixing member A3 can be inspected in various aspects.

In addition, in the present embodiment, the imaging system 6 may further include the distance detection unit 91 to detect a distance between the inspection target object A and the mobile object 3, and the target object detection unit 90 may detect the inspection target object A based on at least one of the first captured image, the second captured image, or the distance between the inspection target object A and the mobile object 3. By using information on the distance between the inspection target object A and the mobile object 3, the accuracy of detection of the inspection target object A can be improved.

### [Other Favorable Embodiments]

In the embodiment described above, although a vehicle is taken as an example of the mobile object, the mobile object according to the embodiment is not limited to a vehicle, and may be a flying object, a ship, and the like. The flying object includes an aircraft, a drone, and the like. The imaging system, the imaging method, the program, and the information processing system according to the embodiment can be applied to inspection of “road attachments” and the like in daily inspection services of roads in social infrastructure business.

As above, although the embodiments have been described, the present invention is not limited to the above embodiments. In other words, various modifications and improvements can be made within the scope of the present invention.

The respective functions of the embodiments may be implemented by one or more processing circuits. Here, in the present specification, a “processing circuit” includes a processor that is programmed by software to execute the respective functions, such as a processor implemented by an electronic circuit, or a device such as an ASIC (Application Specific Integrated Circuit), DSP (digital signal processor), FPGA (field programmable gate array), conventional circuit module, or the like that is designed to execute the respective functions described above.

### RELATED ART DOCUMENTS

### Patent Documents

[Patent Document 1] Japanese Patent No. 6526449

What is claimed is:

1. An imaging system comprising:
an imaging device; and
an imaging control device including a processor and a memory configured to control operations of the imaging device,
wherein the imaging device is installed on a mobile object to image an inspection target object while the mobile object is moving,
wherein a side visible from the imaging device when the inspection target object is positioned in a forward direction with respect to a traveling direction of the mobile object is defined as a front surface of the inspection target object; a side visible from the imaging device when the mobile object is positioned in a sideward direction with respect to the traveling direction is defined as a side surface of the inspection target object; and a side visible from the imaging device when the mobile object is positioned in a backward direction with respect to the traveling direction is defined as a rear surface of the inspection target object,
wherein the imaging device images the front surface of the inspection target object, at a first timing when the inspection target object is positioned in the forward direction with respect to the traveling direction, to obtain a first captured image, and
wherein the processor of the imaging control device controls operations of the imaging device, to obtain a second captured image by imaging at least one of the side surface or the rear surface of the inspection target object, at a second timing when the inspection target object is positioned in at least one of the sideward direction or the backward direction with respect to the traveling direction.

2. The imaging system as claimed in claim 1, wherein the processor is further configured to:
detect the inspection target object based on at least one of the first captured image or the second captured image;
detect damage to the inspection target object based on at least one of the first captured image or the second captured image; and
display a result of detection of the damage on a display.

3. The imaging system as claimed in claim 2, wherein the inspection target object includes a sign, a pillar part supporting the sign, and a fixing member fixing the sign to the pillar part,
wherein the processor detects, based on at least one of the first captured image or the second captured image, at least one of deformation of the sign from a predetermined shape, deformation of the pillar part, or loosening of the fixing member.

4. The imaging system as claimed in claim 2, wherein the processor is further configured to:
detect a distance between the inspection target object and the mobile object; and
detect the inspection target object, based on at least one of the first captured image, the second captured image, or the distance between the inspection target object and the mobile object.

5. An imaging method executed by an imaging system that includes an imaging device and an imaging control device including a processor and a memory configured to control operations of the imaging device,
wherein the imaging device is installed on a mobile object to image an inspection target object while the mobile object is moving,
wherein a side visible from the imaging device when the inspection target object is positioned in a forward direction with respect to a traveling direction of the mobile object is defined as a front surface of the inspection target object; a side visible from the imaging device when the mobile object is positioned in a sideward direction with respect to the traveling direction is defined as a side surface of the inspection target object; and a side visible from the imaging device when the mobile object is positioned in a backward direction with respect to the traveling direction is defined as a rear surface of the inspection target object,
the imaging method comprising:
causing the imaging device to image the front surface of the inspection target object, at a first timing when the inspection target object is positioned in the forward direction with respect to the traveling direction, to obtain a first captured image, and
causing the imaging control device to control operations of the imaging device, to obtain a second captured image by imaging at least one of the side surface or the rear surface of the inspection target object, at a second timing when the inspection target object is positioned in at least one of the sideward direction or the backward direction with respect to the traveling direction.

6. A non-transitory computer-readable recording medium having computer-readable instructions stored thereon, which, when executed, cause an imaging control device in an imaging system that includes an imaging device and the imaging control device including a processor and a memory configured to control operations of the imaging device, to execute a process,
wherein the imaging device is installed on a mobile object to image an inspection target object while the mobile object is moving,
wherein a side visible from the imaging device when the inspection target object is positioned in a forward direction with respect to a traveling direction of the mobile object is defined as a front surface of the inspection target object; a side visible from the imaging device when the mobile object is positioned in a sideward direction with respect to the traveling direction is defined as a side surface of the inspection target object; and a side visible from the imaging device when the mobile object is positioned in a backward direction with respect to the traveling direction is defined as a rear surface of the inspection target object,
the process comprising:
causing the imaging device to image the front surface of the inspection target object, at a first timing when the inspection target object is positioned in the forward direction with respect to the traveling direction, to obtain a first captured image, and
controlling operations of the imaging device, to obtain a second captured image by imaging at least one of the side surface or the rear surface of the inspection target object, at a second timing when the inspection target object is positioned in at least one of the sideward direction or the backward direction with respect to the traveling direction.
